(19) United States
(12) Patent Application Publication
(10) Pub. No.: US 2025/0265781 A1
(43) Pub. Date: Aug. 21, 2025

(54) METHOD AND SYSTEM FOR RECOVERING A THREE-DIMENSIONAL HUMAN MESH IN CAMERA SPACE

(71) Applicant: NAVER CORPORATION, Seongnam-si (KR)

(72) Inventors: Fabien BARADEL, Meylan (FR); Thomas LUCAS, Grenoble (FR); Matthieu ARMANDO, Saint-Jorioz (FR); Salma GALAAOUI, Grenoble (FR); Romain BREGIER, Bougnon (FR); Philippe WEINZAEPFEL, Montbonnot-Saint-Martin (FR); Grégory ROGEZ, Gières (FR)

(21) Appl. No.: 18/987,215

(22) Filed: Dec. 19, 2024

Related U.S. Application Data
(60) Provisional application No. 63/556,100, filed on Feb. 21, 2024.

(51) Int. Cl. G06T 17/20; G05D 1/622; G05D 101/15; G05D 111/10; G06T 13/40; G06V 10/82; G06V 40/10

(52) U.S. Cl. CPC G06T 17/20; G05D 1/622; G06T 13/40; G06V 10/82; G06V 40/10; G05D 2101/15; G05D 2111/10

(57) ABSTRACT

A method for recovering a 3D mesh of N humans in a 3D scene comprises: encoding a 2D image from an image capturing device to extract embedded features for each of a plurality of regions; detecting N humans in N respective regions among the plurality of regions; processing the embedded features in the N respective regions and the embedded features for each of the plurality of regions to predict body model and depth parameters using a decoder comprising a cross-attention module; providing the predicted body model parameters to a 3D parametric model for generating 3D meshes; and placing the generated 3D meshes at respective 3D spatial locations based on the predicted depth parameters.

### PRIORITY CLAIM

This application claims the benefit of and priority to U.S. Provisional Patent Application No. 63/556,100, filed Feb. 21, 2024, which application is incorporated by reference in its entirety herein.

### FIELD

The present disclosure relates generally to machine learning, and more particularly to methods and systems for human mesh recovery (HMR).

### BACKGROUND

For various applications it is useful to provide whole-body mesh recovery from a single image. Whole-body parametric models have been employed in the art for mesh recovery. For example, SMPL-X (Pavlakos et al., Expressive body capture: 3d hands, face, and body from a single image, In CVPR, 2019) can output an expressive mesh for the whole body given a small set of pose and shape parameters. However, it remains difficult to efficiently and accurately provide such parameters, e.g., in real-time. For example, approaches based on optimization such as SMPLify-X remain slow and sensitive to local minima.

Other learning-based methods have been disclosed, but only in single-person settings. Further, such methods pose significant challenges. For example, hands and faces are typically low resolution in natural images, and capturing their poses hinges on subtle details.

Still other approaches leverage a multi-crop pipeline, in which areas of interest such as the face and hands are cropped, resized, and used to estimate the associated meshes. The meshes are then aggregated into a whole-body prediction. For example, ExPose (Choutas et al., Monocular expressive body regression through body-driven attention. In ECCV, 2020) selects high-resolution crops using a body-driven attention mechanism. PIXIE (Feng et al., Collaborative regression of expressive bodies using moderation, In 3DV, 2021) fuses body parts in an adaptive manner. Hand4Whole (Moon et al., Accurate 3d hand pose estimation for whole-body 3d human mesh estimation, In CVPR Workshop, 2022) uses both body and hand joint features for robust 3D wrist rotation estimation.

### SUMMARY

Provided herein, among other things, are methods and systems using one or more processors for recovering a three-dimensional (3D) mesh of N humans in a 3D scene, where N is at least one, and preferably is more than one. An example method comprises: receiving a two-dimensional (2D) image of the scene from an image capturing device, the 2D image including a plurality of regions; by one or more processors, encoding the received image to extract embedded features for each of the plurality of regions; by one or more processors, detecting N humans in N respective regions among the plurality of regions; by one or more processors, processing the embedded features in the N respective regions and the embedded features for each of the plurality of regions to predict body model and depth parameters for each of the N detected humans, wherein the processing uses a decoder comprising a cross-attention module; providing the predicted body model parameters for each of N detected humans to a 3D parametric model for generating N 3D meshes (e.g., respectively for each of the N detected humans in the 3D scene); and placing each of the N generated meshes at a respective 3D spatial location in the 3D scene based on the predicted depth parameters.

According to another embodiment, a system for recovering a three-dimensional (3D) mesh of N humans in a 3D scene is provided comprising: a processor and memory coupled to the processor, the memory including instructions executable by the processor implementing: an encoder configured to receive a two-dimensional (2D) image of the scene including a plurality of regions from an image capturing device and encoding the received image to extract embedded features for each of the plurality of regions; a detector configured to detect N humans at 2D locations in N respective regions among the plurality of regions in the encoded image; a decoder configured to process the embedded features in the N respective regions and the embedded features for each of the plurality of regions to predict body model and depth parameters for each of the N detected humans, said decoder comprising a cross-attention module; a 3D parametric model configured to receive the predicted body model parameters for each of the N detected humans and generate a 3D mesh (e.g., respectively for each of the N detected humans in the 3D scene); and a mesh positioning module configured to place each of the generated N 3D meshes at a respective 3D spatial location in the 3D scene based on the predicted depth parameters and the 2D locations.

According to a complementary aspect, the present disclosure provides a computer program product, comprising code instructions to execute a method according to the previously described aspects; and a computer-readable medium, on which is stored a computer program product comprising code instructions for executing a method according to one or more embodiments and aspects provided herein. The present disclosure further provides a processor configured using code instructions for executing a method according to the provided described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example 3D recovery system architecture.

FIG. 2 shows an example 3D mesh recovery method.

FIG. 3 illustrates operation of an example system architecture for performing a 3D mesh recovery method.

FIG. 4A shows features of an example prediction head for a 3D recovery system architecture.

FIG. 4B shows features of an example block in the prediction head of FIG. 4A.

FIG. 4C shows an example data flow for regressing parameters using the multilayered perceptrons (MLPs) in FIG. 4A.

FIG. 5 shows an example method for generating 3D meshes in a scene using a trained model.

FIG. 6 shows an example input 2D image (left), along with predicted 3D whole-body human 3D meshes and an example side-view of the seven generated 3D meshes (right).

FIG. 7 shows experimental comparisons of example 3D mesh recovery methods for multi-person body-only mesh recovery (top) and single-person whole-body mesh recovery (bottom).

FIG. 8, right, shows an example performance comparison for distance estimation to the state of the art; FIG. 8, left, shows a comparison of methods where camera intrinsics were used to condition an example model.

FIGS. 9-11 show results of example ablation experiments using example 3D mesh recovery methods.

FIGS. 12-13 show example qualitative examples (visualizations) including the input image and example results from an example system architecture (Multi-HMR) overlaid on the image, for various datasets. FIG. 12 shows images from EHF (top), MuPoTs (middle), and UBody (bottom). FIG. 13 shows images from AGORA (top), 3DPW (middle), and CMU (bottom).

FIG. 14 shows examples of rendered avatars and their associated SMPL-X meshes.

FIG. 15 shows examples from a synthetic booster dataset showing the input image, the overlaid SMPL-X annotations, the close-up image, and annotations around the hands corresponding to the rectangle shown in the second column.

FIG. 16 illustrates increasing hand diversity in human shape sources to be rendered.

FIG. 17 shows results of experiments incorporating training with synthetic booster datasets.

FIGS. 18-20 show results of additional ablation experiments.

FIGS. 21-26 show randomly selected images provided from various test and validation datasets used in example experiments, including EHF (FIG. 21), MuPoTS (FIG. 22), AGORA (FIG. 23, CMU panoptics (FIG. 24), 3DPW (FIG. 25), and UBody (FIG. 26).

FIG. 27 shows results of experiments evaluating an impact of focal length.

FIG. 28 shows an example network and hardware system architecture for performing example methods.

In the drawings, reference numbers may be reused to identify similar and/or identical elements.

### DETAILED DESCRIPTION

Example methods and systems herein include or incorporate models for strong multi-person (that is, N people, where N is at least one) three-dimensional (3D) human mesh recovery. Example 3D recovery models can be single-shot, in that they can perform recovery from a single image, e.g., a single two-dimensional (2D) RGB image taken from an image-capturing device, such as a camera (examples of which are generally referred to as “cameras” herein). Predictions generated from example 3D recovery models can encompass or essentially encompass a whole-body, which may include but is not limited to expressions such as face and/or hand expressions. Example predictions provide inputs which can include or be processed to include parameters for a downstream parametric mesh recovery model, a nonlimiting example of which being a SMPL-X parametric model, as well as coordinates for a spatial location in a camera coordinate system. Example 3D mesh recovery methods herein can be faster to train than prior methods, can achieve improved performance, and/or can be more efficient at inference.

Example methods and systems provide, among other things, a framework based on a neural backbone for recovering, e.g., predicting, 3D meshes of humans. The 3D meshes may be, but need not be, whole-body. “Whole-body” refers to a 3D mesh of a complete or near-complete human body (e.g., greater than 80%, 90%, 95%, 98%, or more of a complete 3D outer human body surface, or complete human body parts that have not been occluded from or are not outside the field of view of a scene recorded with an image capturing device). “Humans” or “people” refers herein to providing a plurality of human or humanoid body surface meshes; i.e., multi-person detection.

Example methods and systems may include any combination of one or more of, up to and including all of, the following features:
Models may relatively efficiently detect a variable number of people, including multiple humans, in a scene.
Models may recover whole-body 3D meshes.
Models may be single-shot, in that it recovers the 3D meshes from a single RGB image. “Single-shot” refers to example models performing 3D recovery from a single image input, e.g., by directly regressing an expected output without extracting or resampling features from different crops.
Predicted 3D meshes may be expressive. “Expressive” refers to 3D meshes that capture expressive body poses, such as but not limited to face and/or hand poses, where such poses are available.
Predicted 3D meshes may be positioned in a scene within a spatial location such as a camera space. “Camera space” refers to a 3D space that is definable or defined by a camera coordinate system.
3D recovery may be camera aware. “Camera aware” refers to the 3D recovery being adaptive or adaptable to camera information, when known.

Example 3D recovery models incorporating the above features, referred to herein as Multi-HMR (human mesh recovery) models, are provided herein for illustrating inventive features. An example Multi-HMR model is a real-time single-shot detector that can regress pose and shape parameters of a whole-body model for a variable number of humans as predicted 3D meshes and place the predicted 3D meshes in camera space, and may be conditioned on camera intrinsics when available.

By contrast, methods such as disclosed in Kanazawa et al., End-to-end recovery of human shape and pose, In CVPR, 2018, suggest predicting SMPL mesh parameters and three parameters for weak-perspective reprojection given a cropped image containing a person. Different aspects of this approach have been improved, including architectures, training techniques, and data enhancements. Such approaches have further been extended to whole-body parametric models such as SMPL-X, as disclosed in Pavlakos et al., 2019.

Conventional multi-person mesh recovery methods have included a multi-stage framework, including operating an off-the-shelf human detector, followed by applying a single-person mesh recovery model on crops around each detected person. However, such approaches have drawbacks. For example, they are inefficient at inference time, compared to a single-shot approach. Further, the recovery pipeline cannot be optimized end-to-end. These drawbacks impact overall performance, particularly in cases of truncation by the image frame, or with person-person occlusions, a common scenario in multi-person settings.

Systems such as ROMP (Sun et al., Monocular, one-stage, regression of multiple 3d people. In ICCV, 2021), BEV (Sun et al., Putting people in their place: Monocular regression of 3d people in depth, In CVPR, 2022), and PSVT (Qiu et al., Psvt: End-to-end multi-person 3d pose and shape estimation with progressive video transformers, In CVPR, 2023) recover multiple human meshes in a single step using one-shot detectors. ROMP, for example, estimates 2D maps for 2D human detections, positions, and mesh parameters. A single-stage model, BEV, introduces an additional Bird-Eye-View representation of a scene to predict a relative depth between detected persons. PSVT improves performance using a transformer decoder. However, such systems do not provide whole-body mesh recovery, nor do they consider camera intrinsics for improving accuracy, let alone in combination with regressing a 3D spatial location of each person, e.g., in a camera coordinate system.

Other techniques, such as SPEC and CLIFF, account for certain intrinsic camera parameters for improving reprojection (Kocabas et al., Spec: Seeing people in the wild with an estimated camera. In ICCV, 2021; Li et al., Cliff: Carrying location information in full frames into human pose and shape estimation. In ECCV, 2022) for single-person human detection, especially when these differ between training and inference. However, such techniques do not perform one-shot 3D recovery for multiple humans in a scene, nor do they provide whole-body mesh detection.

Other prior methods such as OSX (Lin et al., One-stage 3d whole-body mesh recovery with component aware transformer, In CVPR, 2023) provide a single-crop method for single-person whole-body mesh recovery by leveraging a vision Transformer (ViT) encoder, followed by a high-resolution feature pyramid, and using keypoint (e.g., wrists) estimates to resample features in a decoder head. However, such methods do not provide multi-person whole-body mesh recovery, let alone by using a single-shot approach. In contrast to earlier approaches, example 3D recovery models herein can be single-shot without requiring high-resolution crops, and further need not require a hierarchical feature extractor.

An example one-stage 3D recovery model herein includes an image encoder, which can be based on, for instance, a trainable neural backbone such as a standard vision Transformer (ViT) backbone to extract embedded features in an image, e.g., as detected token features, where each token corresponds to a region in the image. Detectors are provided that can predict whether a person is present in regions of the image, such as by predicting a coarse 2D person center heatmap, which provides a probability of the presence or absence of a person centered at a given location for each input token.

A decoder, e.g., including a prediction head, can predict for each detected person, body model parameters, such as but not limited to pose and shape parameters, for an expressive human parametric model, such as but not limited to a model such as SMPL-X, as well as location information such as location offset and depth to place people in the scene. The decoder may include a transformer with cross-attention where the queries correspond to the detected token features (e.g., a query per detected center token) and the keys and values correspond to all image features. This allows an example model to share most computations while attending to every region in the input image.

To account for camera intrinsics, which is useful for reasoning and regressing about 3D, a camera intrinsics encoder for encoding, e.g., Fourier-encoding, the viewing directions from the camera can also be provided. The encoded camera intrinsics can be added to (e.g., concatenated with) each token feature upstream of the decoder.

Example 3D recovery models herein have been demonstrated to achieve strong performance on whole-body and body-only benchmarks simultaneously. Experiments were conducted using example methods, referred to herein as Multi-HMR methods. Example Multi-HMR methods notably outperformed existing whole-body methods that require processing multiple high-resolution crops per body part, or hand-designed test-time components for placing people in the scene. Example Multi-HMR methods reached state-of-the-art results on a wide variety of benchmarks. In experiments evaluating example 3D recovery systems using a ViT-S backbone for the image encoder and 448×448 resolution images, such systems were competitive with current state-of-the-art methods, and larger models and higher resolution images provided further performance improvements.

Moreover, example Multi-HMR methods can be relatively efficient compared to prior methods. As a nonlimiting example, in experiments training took only 2 days on a single V100 GPU, significantly less than most existing methods, and ran at 30 fps during inference.

Example 3D recovery models herein may be (but need not be) trained at least in part using synthetic booster datasets. Acquiring high-quality real-world ground truth data at scale for human mesh recovery is costly, particularly when considering faces and hands. This cost can be alleviated by generating large-scale synthetic data. Synthetic booster datasets can contain diverse and clearly visible hand poses, seen from a limited distance (e.g., from humans positioned close to a camera), to allow fine details to be captured.

Such datasets can further improve hand pose predictions when added to training of one-stage whole-body prediction such as provided by example 3D recovery models. Experiments with BEDLAM (Black et al., BEDLAM: A synthetic dataset of bodies exhibiting detailed lifelike animated motion, In CVPR, 2023) and AGORA (Patel et al., AGORA: Avatars in geography optimized for regression analysis, In CVPR, 2021) demonstrate that using large-scale synthetic data can be beneficial for whole-body human mesh regression, as compared to real-world data with pseudo ground-truth fits.

Generated multi-human 3D meshes are useful for various applications. As one example, the ability to condition a motion generation model on both a scene and observed past motion together is useful for navigation applications. For instance, an embodied AI can observe human motion and predict possible futures that make sense in a given environment to successfully interact with humans. An example 3D mesh generator configured for this task can be integrated in, for instance, a simulator to allow training mobile robots in an environment with people. Capturing faces and hands precisely is also key for applications to virtual or augmented reality (AR/VR) or mixed reality (MR), where human body meshes can be directly edited or animated. Generating 3D meshes may also be useful, for instance, in various media applications, e.g., to provide 3D meshes for videos or one or more images (including a sequence of images).

As another example, autonomous device (e.g., robot) navigation in crowded scenes requires robots to achieve their tasks without perturbing or hurting the people around them. Example 3D mesh recovery models can be integrated, for instance, in a collision avoidance pipeline for a robot to safely move in crowded environments. Another example application is co-navigation, where a robot may follow or guide a user and determines whether the person is following, paying attention, etc.

Additionally, the ability to understand human poses, gestures and facial expressions is useful for human-robot Interaction applications. It can also be beneficial for understanding object manipulations or human-human interactions from images or videos. For example, recovered 3D meshes can be analyzed in a downstream task to understand human body language and detect if a person is willing to interact with a robot or not.

### 3D Mesh Recovery Framework and Method

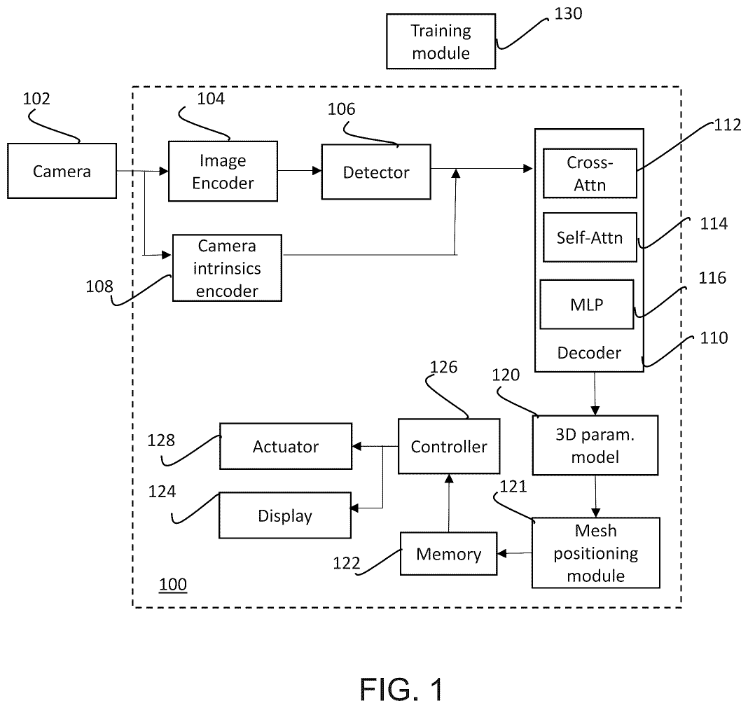

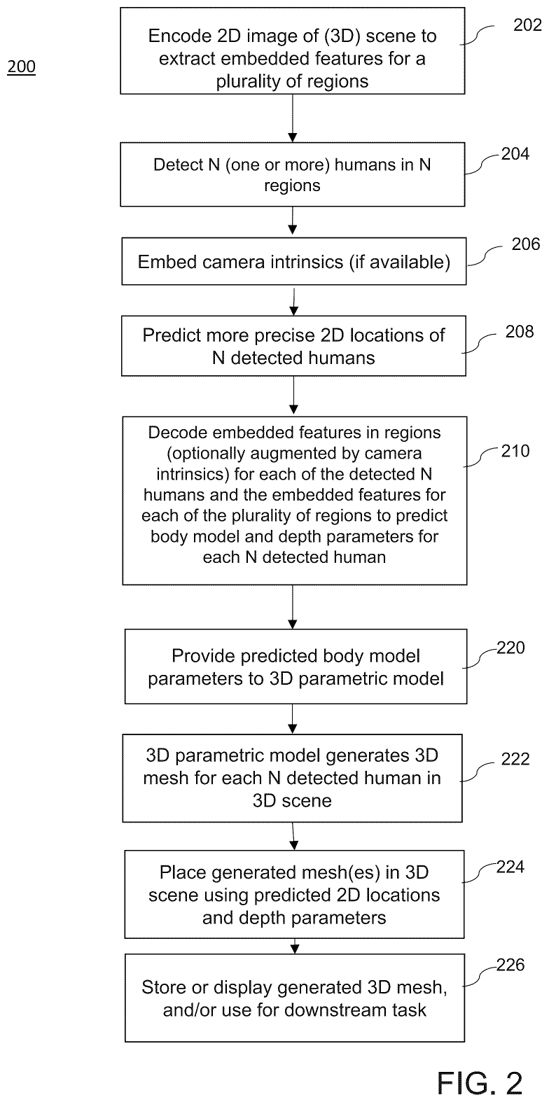

Generally, 3D mesh recovery includes image encoding, detecting humans in the encoded image, and decoding body model parameters and locations from the encoded image to provide inputs for a 3D parametric model. Referring now to the drawings, FIG. 1 shows an example 3D recovery system architecture 100 that may be implemented in or by a processor-controlled device, such as but not limited to a computer or an autonomous device (e.g., a robot), and FIG. 2 shows an example 3D mesh recovery method 200. The system 100 receives a 2D image, such as a (internal or external) 2D red/green/blue (RGB) image of a 3D scene, from an image capturing device such as a camera 102 having a field of view (FOV) of the 3D scene. An image encoder 104, such as a trainable image embedding module, including but not limited to a Vision Transformer (ViT) and/or a convolutional neural network (CNN), encodes the image at 202 to extract embedded image features for a plurality of regions in the image. The 2D image, for example, may be divided into a grid of patches, where each region is represented by a patch. The image encoding or embedding may be provided, for instance, as feature tokens, where each feature token represents features in one of the patches on the grid.

A trainable or trained detector 106 is configured to detect, for each (2D) region in the (2D) grid, whether a human is present at 204. For example, for each feature token, the detector 106 may predict a probability that the token contains a primary keypoint for a human, e.g., a body center such as a head, pelvis, torso, midsection, spine, etc. based on the embedded image features. The detector 106 then extracts N detections, representing N humans, such as by thresholding the predictions. Preferably, N is greater than one, providing multi-human detection from a single shot.

At 206, camera intrinsic parameter information related to each region, e.g., as provided by a camera intrinsics encoder 108, is optionally combined (e.g., concatenated) with the embedded image features for each patch. The camera intrinsics encoder, for instance, may be embodied in a Fourier encoder.

At 208, which may occur before or after concatenating step 206, the detector 106 may further predict a more precise 2D location for each of the N detected humans within the 2D image. To provide a location regression, for each of the N detections, a more exact (or more exact than a center of the region) location of the primary keypoint may be regressed from each respective region where a person was detected into pixel accurate image coordinates using, e.g., a multi-layer perceptron (MLP). For instance, for each region in the 2D grid where a human (e.g., a primary keypoint) was detected, the detector 106 may predict a 2D offset from a center of the region so that the detected 2D location of the human (e.g., of the primary keypoint) can be determined from the 2D location of the region center and the predicted offset.

The embedded image features, optionally augmented by camera intrinsic parameter information (e.g., camera lens focal length and distortion), are input to a trainable or trained decoder 110. The decoder 110 processes at 210 the embedded image features in the N respective regions and the embedded features for each of the plurality of regions to predict, for each of the N detected humans, body model parameters such as but not limited to pose and shape parameters, as well as depth parameters. For instance, to provide body model parameters, each of the N detections (e.g., embedded image features of the N regions where a human was detected) may be run through a cross-attention module such as a cross-attention block 112 and optionally also a self-attention module such as a self-attention block 114 along with the embedded image features for each of the regions to provide N output features. The N output features can then be used to regress N human-centered body model parameters (such as but not limited to pose and shape) and depth parameters for a 3D human mesh, e.g., with one or more shared MLPs 116 or other MLPs (e.g., shared over the N humans). For instance, the N output features may be used to regress N human-centered whole body parameters to provide (at least) pose, shape, and depth parameters for a whole-body 3D human mesh.

At 220, predicted body model parameters from the decoder 110, e.g., pose and shape parameters, are provided (e.g., output) to a (internal or external) 3D parametric model 120. The 3D parametric model 120 converts at 222 body model parameters to N 3D human meshes for placing in camera space. A nonlimiting example 3D parametric model 120 is provided by a SMPL-X model, though other models may be used. The output parameters can vary according to the 3D parametric model provided in the system 100, e.g., by the suitable parameters for a particular parametric model.

At 224, a mesh positioning module 121 places the generated 3D mesh(es) within the 3D scene (e.g., in camera space), such as by using the predicted 2D locations (e.g., centers of 2D grid regions, optionally offset to provide more precise locations) and the depth parameters predicted from the decoder 110.

At 226, the generated 3D human meshes, e.g., with 3D locations, may be stored, e.g., in a non-transitory memory or working memory (e.g., RAM) 122, displayed, e.g., output to a (internal or external) display 124, and/or output to a (internal or external) controller 126 (having memory) for controlling one or more downstream applications. The downstream applications may be performed, for instance, using a display 124 (e.g., displaying 3D avatars in a virtual environment), an actuator 128 for providing controlled movement of an autonomous device, providing feedback, etc.), or other interface or actuation components. A training module 130 may be provided externally or internally to the system 100 for training learnable components such as the image encoder 104, the detector 106, the camera intrinsics encoder 108 (if trainable), and/or the decoder 110. The training module 130 may, but need not, perform end-to-end training.

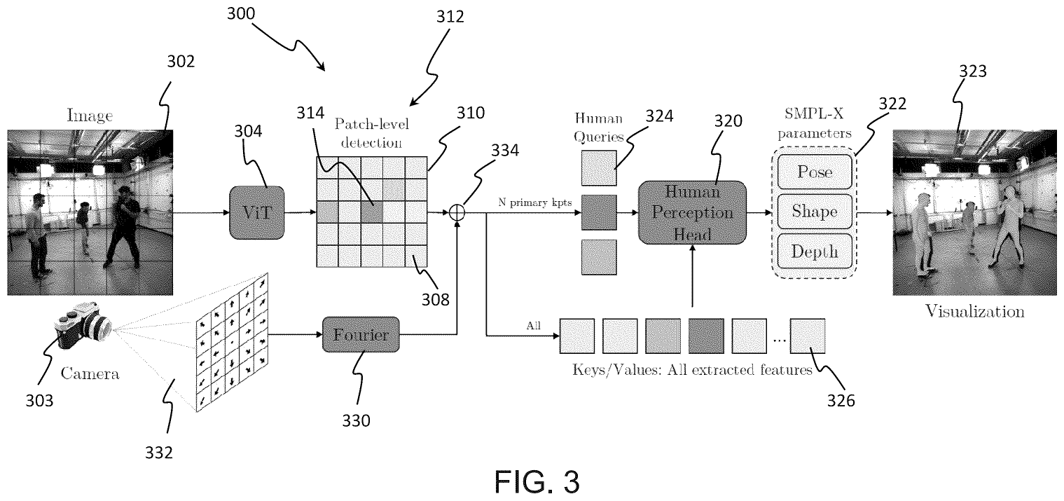

FIG. 3 illustrates operation of a Multi-HMR system architecture 300 for performing a 3D mesh recovery method. The Multi-HMR system 300 may be an example of the system 100. The Multi-HMR system 300 can receive input data including a single-shot input, such as a two-dimensional (2D) red/green/blue (RGB) image (2D image) 302, from an image capturing device such as a camera 303.

To extract features from the input data, e.g., embed image features, the example Multi-HMR system 300 may include a trainable image embedding module 304 (an example of the image encoder 104) with a neural backbone. The image embedding module 304 may be provided by, for example, a Vision Transformer (ViT). An example Vision Transformer is disclosed in Dosovitskiy et al., An image is worth 16×16 words: Transformers for image recognition at scale. In ICLR, 2021. Other example trainable image embedding modules include but are not limited to convolutional neural networks (CNN).

A standard ViT can incorporate pretraining, e.g., large-scale self-supervised pretraining, such as disclosed in Caron et al., Emerging properties in self-supervised vision transformers, In ICCV, 2021., He et al., Masked autoencoders are scalable vision learners, In CVPR, 2022, and/or as disclosed in Oquab et al., Dinov2: Learning robust visual features without supervision. arXiv preprint arXiv: 2304.07193, 2023. However, the image embedding module 304 may be embodied in or include non-standard Vision Transformers or other backbone architectures and/or may be pretrained using other methods.

The image embedding module 304 receives the input data, e.g., 2D RGB image 302, and extracts an image embedding. The image embedding may be embodied, for instance, in a feature tensor, which provides respective feature tokens for each patch, e.g., for patches 308 in a grid 310 of patches representing the image.

For detecting humans in the embedded 2D image, a patch-level detector 312, e.g., detector 106, can regress a person-center heatmap, e.g., in grid 310, from the feature tensor generated by the image embedding module 304. In an example regression method, for each input feature token (token representing features in each patch or region 308), the patch-level detector 312 outputs a prediction (e.g., a probability) that a person is centered on a point, referred to herein as a primary keypoint, that is present in the corresponding input patch. The patch-level detector 312 may further predict a location of the primary keypoint relative to the patch center, e.g., by predicting a location offset.

N humans, associated with N primary keypoints, can be detected, such as by thresholding the probabilities for each input patch. An example patch-level detector 312 may be embodied in a framework analogous to the CenterNet object detection framework disclosed in Zhou et al., Objects as points, In arXiv preprint arXiv: 1904.07850, 2019. For example, in FIG. 3, three primary keypoints, an example of which is indicated at 314, in three respective patches 308 on the grid 310 are detected, and thus N=3. This illustrates that the patch-level detector 312 can perform multi-human detection using a single 2D image 302.

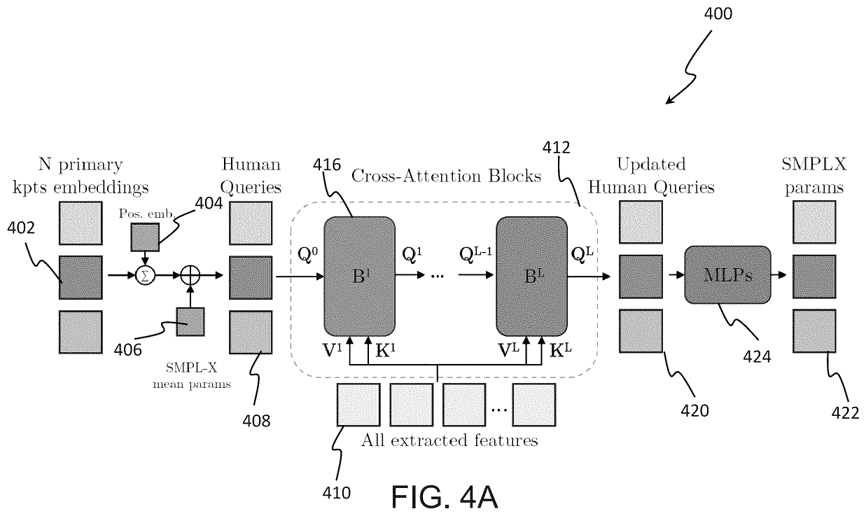

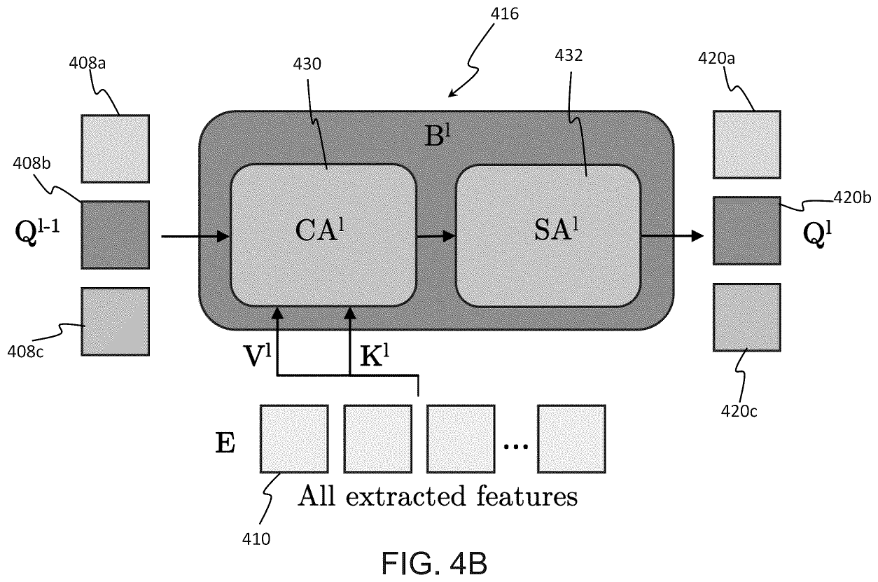

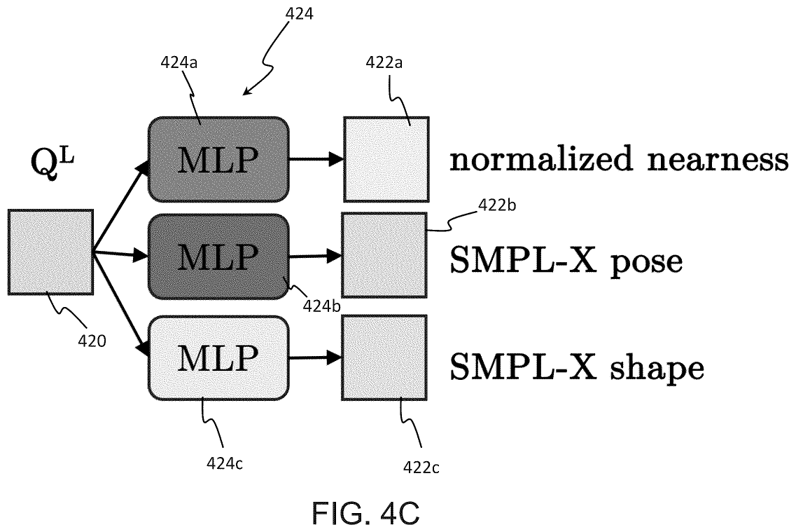

The patch-level detector 312 feeds into a prediction head embodied in a human perception head 320, which is an example of the decoder 110. The human perception head 320 includes a cross-attention module, example details of which are disclosed below regarding FIGS. 4A-4C. The human perception head 320 is configured to predict parameters 322 including, for instance, body model parameters such as pose and shape parameters for an expressive 3D human parametric coding model (e.g., body, hands, face, etc.) for each detected person, as well as depth to place people in a scene (e.g., as shown in visualization 323). A nonlimiting example 3D human parametric coding model is embodied in a SMPL-X model, as disclosed in Choutas et al., Monocular expressive body regression through body-driven attention, In ECCV, 2020.

An example human perception head 320 includes transformer blocks with cross-attention, where the queries 324 correspond to the N detected tokens (and may thus be referred to as “human queries”) and the keys and values 326 are computed from the extracted features in all regions of the image. Such a cross-attention model can allow for most computations to be shared between the (human) queries 324 while attending to every region in the input image 302, though it is possible that fewer regions may be attended to. In this way, the cross-attention module can cross-attend to the entire image to regress features that are not directly shown in the received 2D image. Nonlimiting examples of transformer blocks with cross-attention are disclosed in U.S. Pat. No. 10,452,978, and in Vaswani et al., Attention is All You Need, Advances in Neural Information Processing Systems 30 (NIPS 2017), arXiv: 1706.03762.

To account for camera intrinsics, the Multi-HMR system 300 may further include a camera feature embedding module (an example of the camera intrinsics encoder 108), here embodied in a Fourier encoding module 330. The Fourier encoding module 330 generates a Fourier encoding of the rays 332 (e.g., of the corresponding camera ray directions) going from the camera 303 center. This encoding provides a camera feature embedding that may be combined, e.g., concatenated at 334, with the image feature embedding from the patch-level detection 312 upstream of the human perception head 320.

The embedded camera features can enhance each token feature of the image feature embedding. For instance, the cross-attention module in the human perception head 320 may consider the entire grid 310, updated with camera parameters generated from the Fourier encoding module 330, such that an example grid includes, e.g., for each region (or patch), embedded image features from the image encoder (patch-level detection 312) concatenated with features from the camera intrinsics.

Unlike conventional mesh recovery approaches, example 3D recovery models herein need not rely on additional inputs such as multi-resolution crops of body parts for expressive models, nor hand-designed components to place people in a scene. In this way, example 3D recovery models can be made more efficient than models under existing approaches.

### Multi-HMR Model

The example Multi-HMR method provides multi-person single-shot (or single-stage) 3D human mesh recovery, e.g., whole-body 3D human mesh recovery. Additional features of a 3D recovery model such as the Multi-HMR model will now be described in further detail with reference to FIGS. 3 and 4A-4C.

Given an input (e.g., from a camera 303) RGB image I∈ [symbol] ^{H×W×3} (e.g., 2D image 302) with resolution H×W and a camera intrinsic matrix K∈ [symbol] ^{3×3}, an example 3D recovery model, denoted [symbol] , outputs (e.g., directly outputs) a set of N centered whole-body 3D humans meshes M∈ [symbol] ^{V×3} together with 3D spatial locations t∈ [symbol] ³ in the camera coordinate system:

$${\{ {M}_{n} + {t}_{n} \}}_{n ∈ \{ 1 , … , N \}} = ℋ ( I , K ) . \qquad ( 1 )$$

Human whole-body mesh representation model: An example 3D mesh recovery employs a parametric 3D body model. A nonlimiting example parametric 3D body model is SMPL-X (Choutas et al., Monocular expressive body regression through body-driven attention. In ECCV, 2020), which can represent the human body with controllable face and hands. Given input parameters for the pose θ∈ [symbol] ^{53×3} (global orientation, body, hands, and jaw poses) expressed using axis-angle representation, shape β∈ [symbol] ¹⁰, and facial expression α∈ [symbol] ¹⁰, the SMPL-X model outputs an expressive human-centered 3D mesh M=SMPL−X(θ, β, α)∈ [symbol] ^{V×3}, with V=10475 vertices.

The example mesh M can be centered around a primary keypoint, such as a body center, to center the human 3D representation. Any keypoint can be selected, though it is also contemplated that keypoints may be selected by default. In an illustrative example herein the primary keypoint is selected to be the head. In other examples, the primary keypoint can be the pelvis or other location. Keypoints J may be generally defined as a linear combination of the vertices and may be computed as J=MW, where W is a fixed regressor matrix.

The primary keypoint can be placed in the 3D scene by translating the primary keypoint by a 3D translation t. Put another way, a translation t of a human in a scene may be expressed as the 3D position of the primary keypoint from the camera.

For simplicity of explanation, let x=[θ, β, α]. The problem then reduces to predicting x and t for all detected humans. An example 3D recovery model thus predicts for each person human-centered SMPL-X (or other 3D parametric model) parameters x and 3D translation t, e.g., expressed in the camera coordinate system.

Camera model: Knowing camera intrinsic parameters decreases prediction uncertainty when estimating 3D poses and positions in the 3D scene. Although other camera models may be considered, an example method assumes a simple pinhole camera model to project points in the 3D space into the image plane. For sake of simplicity of explanation, and ignoring distortion for illustration, the camera 303 may be defined by an intrinsic matrix K (e.g., K∈ [symbol] ^{3×3}), with focal length f (or field of view (FOV)) and principal point parameters (pᵤ, pᵥ). An example projection model can assume, for instance, a pinhole camera model and denote an intrinsic matrix input, though other assumptions may be used. Focal length f can also be derived from FOV, or vice versa. If K is not available for a particular camera, a library, such as but not limited to SPEC-CamCalib, may be used to provide an estimate for K. Focal lengths or FOVs may be retrieved for use, computed online or in real-time, or provided using a combination of retrieved and computed parameters.

The camera pose may be (for example) set to the origin. Let t=(tₓ, t_{y}, t_{z}) be a 3D point. This can provide:

$$K = [ \begin{matrix}f & 0 & {p}_{u} \\ 0 & f & {p}_{v} \\ 0 & 0 & 1\end{matrix} ] and \{ \begin{matrix}{[ {c}_{u} , {c}_{v} , 1 ]}^{T} = ( 1 / {t}_{z} ) \cdot {K [ {t}_{x} , {t}_{y} , {t}_{z} ]}^{T} \\ {[ {t}_{x} , {t}_{y} , {t}_{z} ]}^{T} = ( {t}_{z} ) \cdot {{K}^{- 1} [ {c}_{u} , {c}_{v} , 1 ]}^{T}\end{matrix} , \qquad ( 2 )$$

where c=(cᵤ, cᵥ) represents the 2D image coordinates of the projection of t into the image plane. The camera intrinsic matrix K can thus be used to backproject a 2D point in the image into a 3D point given t_{z}, which is the depth at a given pixel. One can denote by π_{K} the camera projection operator and π_{K}⁻¹ the camera inverse projection operator.

### Single-Shot System Architecture

The example 3D recovery system, e.g., Multi-HMR system 300, performs a single-shot (or one-stage) 3D projection method for multiple humans in a scene. Generally, the VIT-based image embedding module 304 encodes images 302 from the camera 303 into token embeddings, e.g., representing a grid 310 of patches 308 making up the image. The patch-level detector 312 processes these token embeddings to detect humans. The token embeddings (in this example) are combined via concatenation 334 with camera embeddings from Fourier encoding module 330, and the (e.g., combined) token embeddings are used as human queries 324 and keys/values 326 by the human perception head 320 to regress whole-body human meshes and depth parameters 322. The Human Perception Head 320 may be trained, for instance, from scratch.

An example operation of the Multi-HMR system 300 will now be described in more detail.

Image embedding: The input RGB image I may be encoded with the ViT-based image embedding module 304, such as the backbone described in Dosovitskiy et al., An image is worth 16×16 words: Transformers for image recognition at scale, In ICLR, 2021. For example, the image may be sub-divided into a grid 310 of image patches 308 of size P×P, each embedded into tokens with a (e.g., learned) linear transformation and positional encoding. For clarity of explanation, for an input RGB image I∈ [symbol] ^{H×W×3} it may be assumed that H and W are divisible by P to subdivide the image into image patches of size P×P, but if not, the sub-division may be otherwise configured. The set of tokens may be processed with self-attention blocks into an embedded image E_{I}∈ [symbol] ^{H/P×W/P×D} with D the feature dimension. An example ViT model may keep a constant resolution throughout, so that each output token can spatially correspond to a patch in the input image.

Patch-level detection: To detect humans in the input image 302, an example 3D projection method performed by the patch-level detector 312 can be configured generally similarly to the CenterNet paradigm, as disclosed for instance in Zhou et al., Objects as points, In arXiv preprint arXiv: 1904.07850, 2019. Since, for instance, a person can belong to multiple patches in the image an example method considers a primary keypoint. As provided above, a primary keypoint on human bodies may be selected or set by default, a non-limiting example of which being the head, though other choices are possible, such as the pelvis, etc.

For each patch index (i, j)∈{1, . . . , H/P}×{1, . . . , W/P}, the example patch-level detector 312 predicts whether the patch centered at u^{i,j}=(uⁱ, v^{j}) contains a primary keypoint, for instance using a score s^{i,j}∈[0,1] (or other scale), which score may be computed from the associated token embedding E_{I}^{i,j}∈ [symbol] ^{D}, e.g., using a Multi-Layer-Perceptron (MLP).

At inference, a threshold t (a nonlimiting example being 0.5, though this can be higher or lower) may be applied to the scores to detect patches containing primary keypoints, e.g., to provide a binary decision:

$${\{ {u}_{n} \}}_{n} = \{ {u}^{i , j} \vert {s}^{i , j} \geq τ \} . \qquad ( 3 )$$

At training time, the ground-truth detections may be used for the rest of the model. The MLP may be shared across each token, and a score map S may be obtained indicating at each location (i, j) if a human is detected. The score map can be obtained for the entire image, and by applying a threshold on the scores only patches where a primary keypoint is detected may be kept, e.g., the three patches 314 identified in the example grid 310 in FIG. 3.

Image coordinates regression: Detecting people at the patch-level yields a rough estimation of the 2D location of the primary keypoint (projected into the camera plane), up to the size of the predefined patch size P. For illustration, a nonlimiting example patch size is 14 pixels (in each of W and H directions), though this number may be greater or smaller. Example methods can further refine the 2D location of the primary keypoint from the center of a patch (uⁱ, v^{j}) by regressing a residual offset δ=(δᵤ, δᵥ) from the corresponding token embedding E_{I}^{i,j} using an MLP. The final pixel coordinates of the primary keypoint detected at patch location (i, j) may be given by:

$${c}^{i , j} = [ {u}^{i} + {δ}_{u} , {v}^{j} + {δ}_{v} ] . \qquad ( 4 )$$

For example, if N patches each contain a primary keypoint, an example method can output N 2D camera coordinates {c}_{1 . . . N} which correspond to the pixel location of N primary keypoints.

To place the primary keypoint in the 3D scene, expressed in the camera coordinate system, cᵢⱼ may be unprojected using the depth of the primary keypoint d:

$$t = {{K}^{- 1} [ {u}_{i} + {δ}_{u} , {v}_{j} + {δ}_{v} , d ]}^{T}$$

Camera embedding: Since both RGB image and camera information can play a useful role for understanding the 3D environment as explained above, camera information may be used as additional input to the perception module, e.g., Human Perception Head 320. Camera information may be separately embedded, for instance, by computing the ray direction r_{i,j}=K⁻¹[uᵢ, vⱼ, 1]^{T} from each patch center (uᵢ, vⱼ), such as by using the method disclosed in Mildenhall et al., Nerf: Representing scenes as neural radiance fields for view synthesis, In ECCV, 2020.

The first two values of the rᵢⱼ vector may be kept, optionally L₂ normalized, and embedded into a high-dimensional space using Fourier encoding, such as disclosed in Mildenhall et al., 2020, to obtain a patch-level geometric embedding E_{K}∈ [symbol] ^{H/P×W/P×2(F+1)}, where F is the number of frequency bands. Extracted features may be concatenated with camera embeddings to get E=E_{I} ⊕E_{K}, where ⊕ denotes concatenation along the channel axis. If the camera intrinsics matrix is unknown, the field of view may be set to a default number, for instance, 60 degrees, and the principal point to the image center.

Human Perception Head: Example methods predict human-centered meshes and depths for all people detected in the scene in a structured manner and in parallel, by processing E with a decoder. An example decoder is embodied in a Human Perception Head 320. The Human Perception Head 320 may include cross-attention blocks, e.g., as disclosed in Jaegle et al., Perceiver: General perception with iterative attention, In ICML, 2021.

FIGS. 4A-4C illustrate features of a Human Perception Head 400, which is an embodiment of the Human Perception Head 320. The Human Perception Head 400 allows features corresponding to a person detection to attend information from all image patches before making a full pose, shape and depth prediction for this person. In this way, human properties for all detected humans may be estimated all at once using a cross-attention based prediction head, providing efficient decoding.

In example methods, there may be as many input queries to the cross-attention mechanism as detected humans, while keys and values may come from E. Such an example framework is well suited to a structured set prediction task. For example, given N detected humans, an example method initializes N cross-attention queries {qₙ}ₙ. Assuming qₙ 402 was detected at patch (i, j), then qₙ=(E^{i,j} ⊕x̅)+p^{i,j} where p^{i,j} is a learned query initialization 404, dependent on position, and x̅ denotes the mean body model parameters 406, of dimension D′, similar to that disclosed in Goel et al., Humans in 4d: Reconstructing and tracking humans with transformers, In ICCV, 2023; and in Kolotouros et al., Learning to reconstruct 3d human pose and shape via model-fitting in the loop, In ICCV, 2019. The queries 408 may be stacked into Q⁰∈ [symbol] ^{(D+D′)×N} for efficient processing in parallel. For instance, FIG. 4B shows stacked input queries 408a, 408b, 408c for N=3 The full feature tensor E is used as cross-attention keys and values 410, so that predictions may be made from the full image.

The queries 408 are then updated with a stack 412 of L blocks B^{l} 416 (as a nonlimiting example, L=2), alternating between a cross-attention layer (CA) over queries and features and a self-attention layer (SA) over queries:

$${Q}^{l} = {B}^{l} ( [ {Q}^{l - 1} , E ] ) = {SA}^{l} ( {CA}^{l} [ {Q}^{l - 1} , E ] ) . \qquad ( 5 )$$

FIG. 4B shows an example block B^{l} 416 including a cross-attention layer CA^{l} 430 that outputs to a self-attention layer SA^{l} 432. The cross-attention layer CA^{l} 430 processes over queries Q^{l-1} and features represented by key and value pairs V^{l}, K^{l} from extracted features E 410, while the self-attention layer SA^{l} 432 processes over queries. Example features of cross-attention and self-attention blocks 430, 432 are disclosed in U.S. Pat. No. 10,452,978, and in Vaswani et al., 2017.

The final outputs 420 of the cross-attention module 412 are given by Q^{L}∈ [symbol] ^{(D+D′)×N} and may be viewed as a set of N output features, e.g., output features 420a, 420b, 420c in FIG. 4B. The output features are used to regress N human-centered whole-body parameters {xₙ}ₙ 422 with MLPs 424. This provides an expressive human-centered mesh M for each query.

FIG. 4C shows an example regression method for an updated query Q^{L} 420. The updated query Q^{L} 420 is input to different multilayer perceptrons (MLPs) 424a, 424b, 424c for regressing parameters for depth (e.g., normalized nearness) 422a, SMPL-X pose 422b, and SMPL-X shape 422c for each of N humans. The pose and shape parameters to be predicted may depend on the 3D parametrization model, and will be appreciated by an artisan. An example depth parametrization, normalized nearness will now be described.

Depth parametrization: Similar to approaches for monocular depth (Mertan et al., Single image depth estimation: An overview, Digital Signal Processing, 2022; and Weinzaepfel et al, CroCo v2: Improved cross-view completion pretraining for stereo matching and optical flow, In ICCV, 2023), the depth d can be predicted in log-space (also called nearness, denoted v). Since depth estimation can depend on camera parameters (e.g., focal length, FOV, etc.), example methods regress a normalized nearness \hat{η} from Q^{L} using an MLP, assuming a standard focal length \hat{f}:

$$\{ \begin{matrix}η = \frac{\hat{f}}{f} \hat{η} \\ d = exp ( - η )\end{matrix} \qquad ( 6 )$$

This parametrization improves robustness to changes in the focal length f (e.g., as suggested by Facil et al., Camconvs: Camera-aware multi-scale convolutions for singleview depth. In CVPR, 2019).

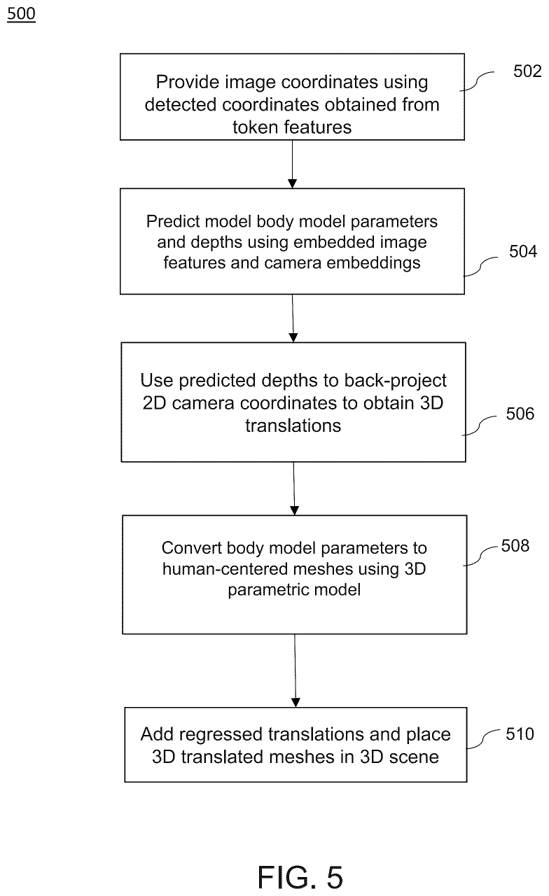

Inference: FIG. 5 shows an example inference method 500 for generating 3D meshes in a scene, e.g., using Multi-HMR. Detected coordinates {uₙ}ₙ obtained from token features E_{I} following Equation (3) are refined at 502 into images coordinates {cₙ}ₙ following Equation (4). At 504, image features E_{I} and camera embeddings E_{K} are used to predict body model parameters {xₙ}ₙ and depths {dₙ}ₙ following Equation (6). At 506, the predicted depths can be used to back-project the 2D camera coordinates {cₙ}ₙ using the camera inverse projection operator π_{K}⁻¹ following Equation (2) to obtain the 3D translations {tₙ}ₙ of primary keypoints. At 508, body model parameters are converted to human-centered whole-body (for instance) meshes {Mₙ}ₙ using the SMPL-X model (an example of the 3D parametric model 120). At 510, the final outputs {Mₙ+tₙ}ₙ are placed in the scene by adding the regressed translations. Back-projecting step 506 and/or placing step 510 may be performed, for instance, by the mesh positioning module 121.

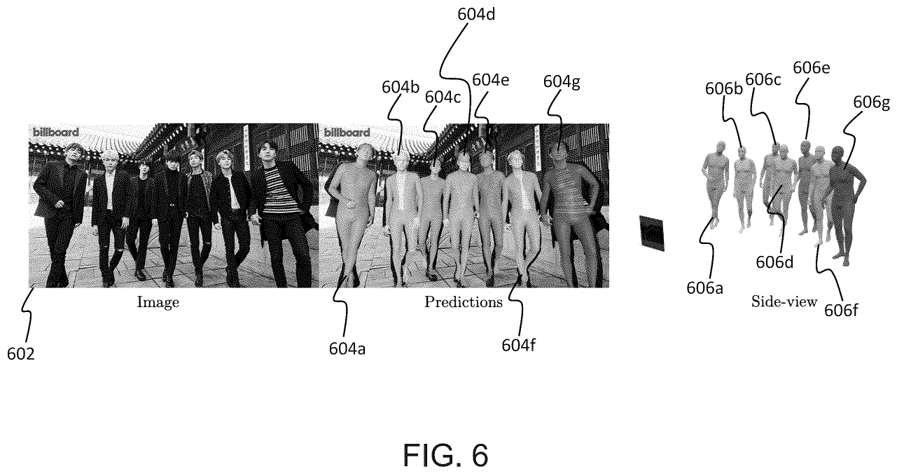

FIG. 6 shows an example input 2D image 602 (left), along with predicted 3D whole-body human 3D meshes 604a-604g (N=7 in this example). Example side-views 606a-606g of the seven generated whole-body 3D meshes is also illustrated (right).

Training: Example 3D mesh recovery methods can be fully-differentiable and trained end-to-end by back-propagation. Example training losses will now be discussed. A tilde ˜ denotes ground-truth targets.

Detection Loss: For detection loss, the ground-truth primary keypoint of each human present in the image may be projected using, for instance, the camera projection operator π_{K}, and a score map \tilde{S} of dimension (W/P)×(H/P) can be constructed with S^{i,j} equal to 1 if a primary keypoint is projected to the corresponding patch and 0 otherwise. Predictions can be trained by minimizing a binary cross-entropy loss:

$${ℒ}_{det} = - {\sum }_{i , j} {\tilde{s}}^{i , j} log ( {s}^{i , j} ) + ( 1 - {\tilde{s}}^{i , j} ) log ( 1 - {s}^{i , j} ) . \qquad ( 7 )$$

Regression losses: All other quantities predicted by the model may be trained with, for instance, L₁ regression losses. Example methods concatenate the offset from the patch centers \tilde{c}, the body model parameters (pose, shape, expression) \tilde{x} (e.g., using methods similar to those disclosed in Goel et al., Humans in 4d: Reconstructing and tracking humans with transformers. In ICCV, 2023.; and Kolotouros et al., Learning to reconstruct 3d human pose and shape via model-fitting in the loop, In ICCV, 2019) as well as the depth \tilde{d}, and minimize [symbol] ₚₐᵣₐₘₛ=Σₙ|[c, x, d]−[\tilde{c}, \tilde{x}, \tilde{d}]|. It is also beneficial (e.g., to speed up convergence) to minimize an L₁ loss for human-centered output meshes [symbol] ₘₑₛₕ=Σₙ|Mₙ−\tilde{M}ₙ|, as well as for the reprojection of the mesh expressed in camera coordinates space into the image plane [symbol] ᵣₑₚᵣₒⱼ=Σₙ|π_{K} (Mₙ+tₙ)−π_{K}(\tilde{M}ₙ+\tilde{t}n)|.

The final example training loss is thus (with weighting parameter λ, which may depend on the number of vertices considered, the units used for camera coordinates, or other factors):

$$ℒ = {ℒ}_{det} + {ℒ}_{params} + λ ( {ℒ}_{mesh} + {ℒ}_{reproj} ) . \qquad ( 8 )$$

Synthetic whole-body data: In example methods, synthetic data may be configured to contain i) diverse hand poses and ii) close-up views of clearly visible hands. Synthetic data may be rendered, for instance, using Blender (https://www.blender.org/) synthetic human models close to the camera in poses sampled from BEDLAM (Black et al, BEDLAM: A synthetic dataset of bodies exhibiting detailed lifelike animated motion. In CVPR, 2023), AGORA (Patel et al., AGORA: Avatars in geography optimized for regression analysis, In CVPR, 2021), and UBODY (Li et al., Cliff: Carrying location information in full frames into human pose and shape estimation, In ECCV, 2022) datasets, using additional hand poses from InterHand (Moon et al., Interhand2. 6m: A dataset and baseline for 3d interacting hand pose estimation from a single rgb image, In ECCV, 2020) for increased diversity.

In experiments described herein, for instance, images were generated using example synthetic data generation methods. Simply adding this data to the training was shown to improve the quality of hand pose predictions, without degrading other metrics.

### Experiments

In experiments, example Multi-HMR models were evaluated on various benchmarks, including both body-only mesh recovery datasets such as 3DPW (von Marcard et al., Recovering accurate 3d human pose in the wild using imus and a moving camera. In ECCV, 2018), MuPoTs (Mehta et al., Single-shot multi-person 3d pose estimation from monocular rgb. In 3DV, 2018), CMU-Panoptic (Joo et al., Panoptic studio: A massively multiview system for social motion capture, In ICCV, 2015), AGORA-SMPL (Patel et al., AGORA: Avatars in geography optimized for regression analysis. In CVPR, 2021), as well as whole-body mesh recovery datasets such as EHF (Pavlakos et al., Expressive body capture: 3d hands, face, and body from a single image, In CVPR, 2019), AGORA-SMPLX (Patel et al., 2021), and UBody (Lin et al, One-stage 3d whole-body mesh recovery with component aware transformer. In CVPR, 2023).

Using a ViT-S backbone and 448×448 image inputs, example Multi-HMR models matched the performance of current state-of-the-art approaches on both body-only and whole-body benchmarks. An example Multi-HMR model allowed for real-time applications with 30 frames per second inference speed on a single V100 GPU, and training took about two days on a single V100 GPU, which was significantly faster than most methods. Larger backbones and higher resolutions, e.g., up to a ViT-L backbone and 896×896 backbone, was shown to significantly improve performance over state-of-the-art approaches, at the cost of slower inference.

Additional experiments supplemented the training data of example Multi-HMR models with a synthetic booster dataset that contained images of people close to a camera, with diverse and expressive hand poses. The additional training data further improved performance on hand predictions.

### Datasets and Metrics

BEDLAM is a large-scale multi-person synthetic dataset composed of 300 k images for training including diverse body shapes, skin tones, hair and clothing. Synthetic humans are built by using a SMPL-X mesh and adding some assets such as clothes and hair. In each scene there are from 1 to 10 people with diverse camera viewpoints. The test set is composed of 16 k images.

AGORA is a multi-person high realism synthetic dataset which contains 14 k images for training, 2 k images for validation and 3 k for testing. It includes 4,240 high-quality humans scans each fitted with accurate SMPL and SMPL-X annotations. Results on the test set are obtained using an online leaderboard for SMPL and SMPL-X results. Results on the validation for the distance estimation are also provided since the leaderboard does not give this metric on the test set.

3DPW is an outdoor multi-person dataset composed of 60 sequences which contain respectively 17 k images for training, 8 k images for validation and 24 k images for testing. This has been the first in-the-wild dataset in this domain for evaluating body mesh reconstruction methods.

MuPoTs is an outdoor multi-person dataset captured in a multi-view setting. The dataset is composed of 8 k frames from 20 real-world scenes with up to three subjects. This dataset was used for evaluation only. Poses are annotated in 3D with 14 body joints.

CMU Panoptic is a large-scale controlled environment multi-person dataset captured by multiple cameras. Each person is annotated with 14 joints in 3D. Following prior works (e.g., Jiang et al., Coherent reconstruction of multiple humans from a single image, In CVPR, 2020; Qiu et al., Psvt: End-to-end multi-person 3d pose and shape estimation with progressive video transformers, In CVPR, 2023) four sequences were used, which leads to a test set composed of 9 k images.

EHF is the first evaluation dataset for SMPL-X based models. It was built using a scanning system followed by a fitting of the SMPL-X mesh. It is a single person whole-body pose dataset composed of 100 images.

UBody (Lin et al, One-stage 3d whole-body mesh recovery with component aware transformer. In CVPR, 2023) is a large-scale dataset covering a wide range of real-life scenarios such as fitness videos, VLOGs or sign language. Most of the time only the upper body part of the persons is visible. The inter-scene protocol was used where there are 55 k images for training and 2 k images for testing.

Metrics Descriptions: Prior work on multi-person human mesh recovery proposed metrics that can be separated into three categories: i) metrics that evaluate the reconstruction of the human mesh, centered around the root joint; ii) metrics that evaluate detection and iii) metrics that evaluate the prediction of spatial location.

Human-centered mesh metrics: To evaluate the predicted human mesh, experiments centered both estimated and ground-truth human meshes around the pelvis joint. They use per-vertex error (PVE) to evaluate the accuracy of the entire 3D mesh. When available, PVE computed on vertices corresponding to the face and hands only (PVE-Face and PVE-Hands) was also reported. Because global orientation mistakes heavily impact the PVE, prediction quality was also assessed without taking the global orientation into account by reporting all these metrics after Procrustes-Alignment (denoted with the prefix PA). Since some human body datasets do not have mesh ground-truths but only 3D keypoints, Mean Per Joint Position Error (MPJPE) was also reported on the 14 LSP 3D keypoints as well as the Percentage of Correct Keypoints (PCK) using a threshold of 15 cm.

Detection metrics: Evaluating detection experiments relied on the Recall, Precision and F1-Score metrics. On some datasets, it is also common to report normalized mean joints error (NMJE) and normalized mean vertex error (NMVE), which are obtained by dividing mean joint errors and mean vertex errors by the F1-Score. This produces a score sensitive to both reconstruction quality and detection.

Spatial location metrics: To evaluate distance predictions the Mean Root Position Error (MRPE) was used by using the pelvis as root keypoint.

Implementation details: An example method by default used squared input images of resolution 448×448, with the longest side resized to 448 and the smallest zero-padded to maintain aspect ratio. Only random horizontal flipping was used as data augmentation, though additional, or more complicated data augmentations schemes may be used (but may not always bring significant gains).

The weights of the backbone were initialized with DINOv2, as disclosed in Qquab et al., 2023. Experiments used Small, Base and Large ViT models as encoder. Experiments uses a batch-size of 8 images, and an initial learning rate of 5e-5, and the example model was trained with automated mixed precision (Micikevicius et al., Mixed precision training, In ICLR, 2018) for 400 k iterations. At resolution 448×448, training a ViT-S (resp. ViT-L) took around 2 (resp. 5) days on a single NVIDIA V100. The default detection threshold was t=0.5. Experiments used the neutral SMPL-X model with 10 shape components.

Evaluation benchmarks: Because example 3D recovery methods uniquely can be used to provide single-stage multi-person whole-body human mesh recovery, example methods were evaluated on both body only benchmarks and whole-body benchmarks to compare against prior works.

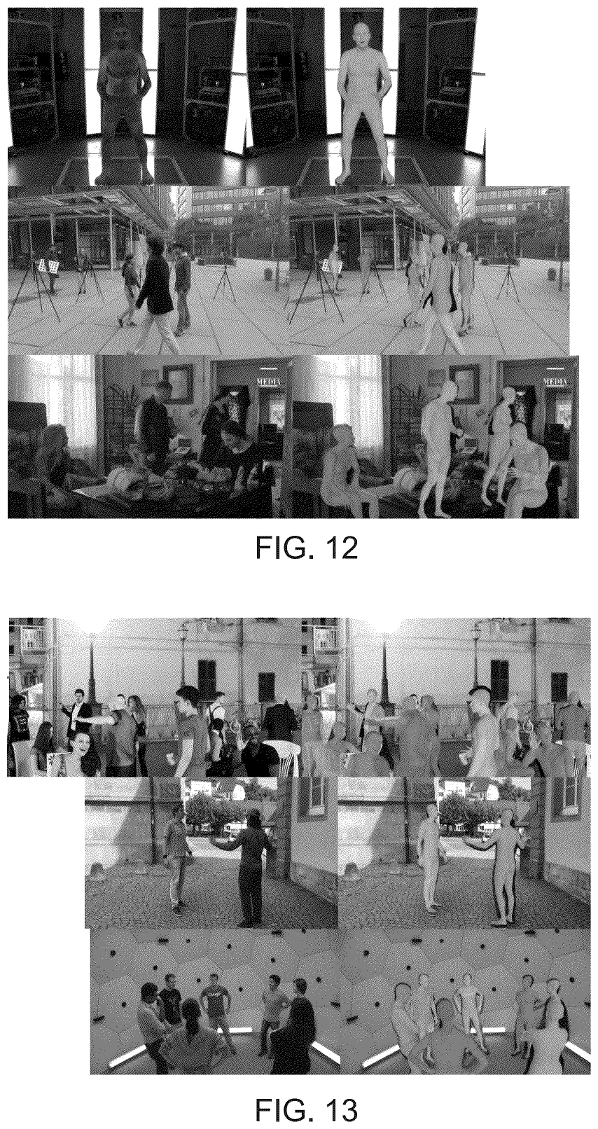

For body-only benchmarks, experiments predicted SMPL meshes from SMPL-X meshes using the regressor from Black et al., 2023, and follow prior work (Lin et al., One-stage 3d whole-body mesh recovery with component aware transformer; In CVPR, 2023; Moon et al., Accurate 3d hand pose estimation for whole-body 3d human mesh estimation, In CVPR Worskhop, 2022; Qiu et al., Psvt: End-to-end multi-person 3d pose and shape estimation with progressive video transformers, In CVPR, 2023; Sun et al., Monocular, one-stage, regression of multiple 3d people, In ICCV, 2021; and Sun et al., Putting people in their place: Monocular regression of 3d people in depth. In CVPR, 2022) in evaluating on 3DPW (von Marcard et al., 2018), MuPoTs (Mehta et al., Single-shot multi-person 3d pose estimation from monocular rgb. In 3DV, 2018), CMU (Joo et al., Panoptic studio: A massively multiview system for social motion capture, In ICCV, 2015) and AGORA (Patel et al., AGORA: Avatars in geography optimized for regression analysis. In CVPR, 2021). Example qualitative examples (visualizations) are shown in FIGS. 12-13, including the input image and example results from Multi-HMR overlaid on the image. FIG. 12 shows images from EHF (top), MuPoTs (middle), and UBody (bottom). FIG. 13 shows images from AGORA (top), 3DPW (middle), and CMU (bottom).

For whole-body evaluation, performance of example 3D recovery models was compared to prior methods (Feng et al., Collaborative regression of expressive bodies using moderation, In 3DV, 2021; Lin et al., One-stage 3d whole-body mesh recovery with component aware transformer, In CVPR, 2023; and Moon et al., Accurate 3d hand pose estimation for whole-body 3d human mesh estimation, In CVPR Worskhop, 2022) on EHF (Pavlakos et al., Expressive body capture: 3d hands, face, and body from a single image. In CVPR, 2019), AGORA, and UBody, although such existing methods are single-person only and therefore not directly comparable.

Evaluation metrics: Standard metrics (Lin et al., One-stage 3d whole-body mesh recovery with component aware transformer, In CVPR, 2023; Sun et al., Monocular, one-stage, regression of multiple 3d people. In ICCV, 2021; Sun et al., Putting people in their place: Monocular regression of 3d people in depth, In CVPR, 2022) were reported with the per-vertex error (PVE) to evaluate the accuracy of the entire 3D mesh as well as of specific body parts (hands and face). When the entire ground-truth mesh was not available, the Mean Per Joint Position Error (MPJPE) and the Percentage of Correct Keypoints (PCK) were reported using a threshold of 15 cm. Metrics after Procrustes-Alignment (PA) were also reported as well as the F1-Score to evaluate detection.

Comparisons with state-of-the-art methods: To compare example 3D recovery methods against state-of-the-art approaches, experiments used two settings with a ViT-L backbone: image resolution of 896×896, which yields optimal performances, and of 448×448 for SMPL benchmarks, denoted Multi-HMR-448, as it offers a good speed-performance trade-off and is more comparable to some existing methods which use 512×512 images.

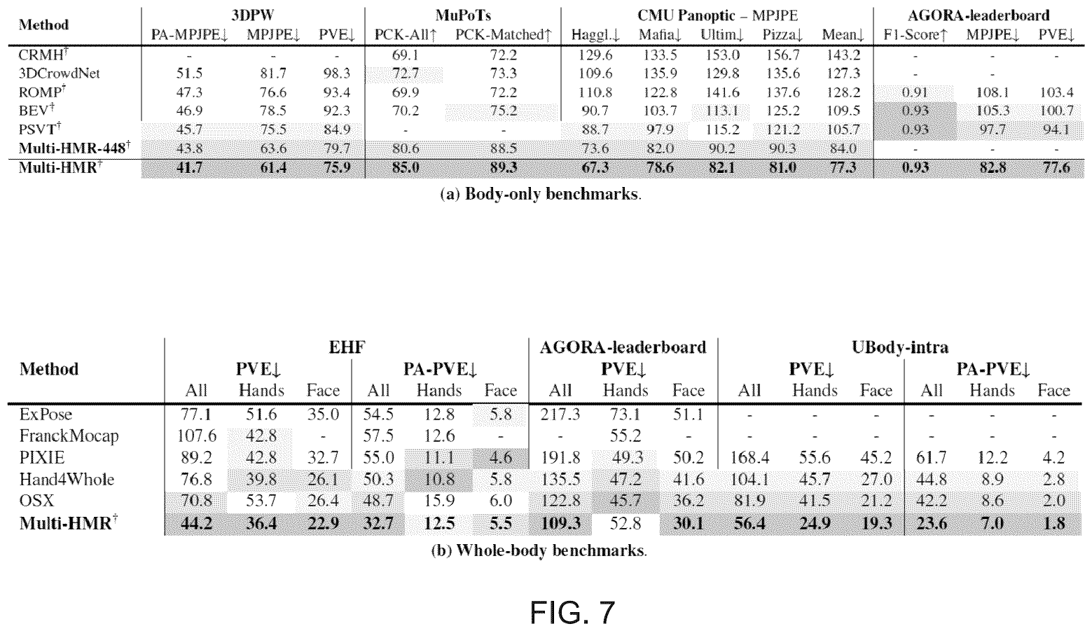

Body Mesh Recovery: Example methods were compared against multi-person state-of-the-art methods such as ROMP, BEV, and PSVT, in FIG. 7, top. The example Multi-HMR methods produced whole-body outputs, with predictions for faces and hands, while achieving high performance on all body-only benchmarks. Quantitative performance was improved by a significant margin.

Whole-Body Mesh Recovery: Since no previous multi-person whole-body human mesh approaches are believed to exist, example 3D recovery methods were compared in experiments against single-person whole-body 3D pose methods. These approaches do not consider the detection stage and the 3D positions in the scene, and assume predefined 2D bounding boxes around the person of interest. Results are shown in FIG. 7, bottom. While being able to detect multiple persons in a single shot, the example Multi-HMR method outperformed previous methods on whole-body human mesh benchmarks on most metrics, especially when considering the entire mesh. Multi-HMR obtained competitive performance on hands and faces, with reconstruction errors on par with or better than OSX, and it performed best for the whole mesh and the face on AGORA.

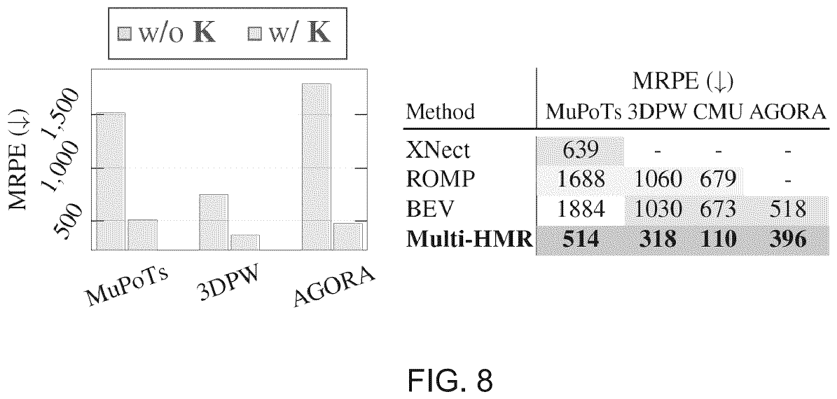

Depth estimation: FIG. 8, right, shows a performance comparison in distance estimation to the state of the art, as disclosed in Mehta et al., Xnect: Real-time multi-person 3d motion capture with a single rgb camera, ACM Trans. Graph., 2020; Sun et al., Monocular, one-stage, regression of multiple 3d people, In ICCV, 2021; Sun et al., Putting people in their place: Monocular regression of 3d people in depth, In CVPR, 2022. Prior works assumed a fixed camera setting. For example, BEV is competitive on AGORA-val but does not generalize as well to datasets with different cameras. Since Multi-HMR is camera-aware, it gives accurate distance predictions across datasets and camera parameters (focal, principal point).

### Additional Experiments

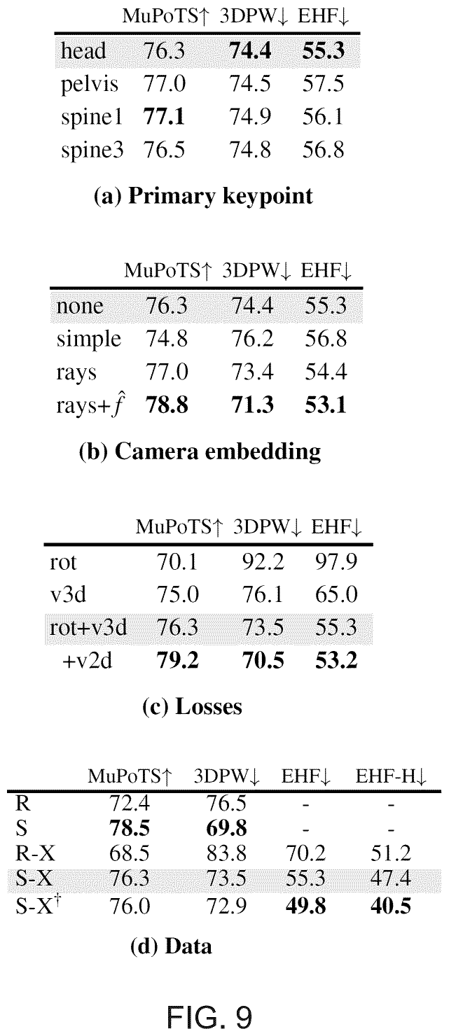

Primary keypoint: FIG. 9(a) shows results with different choices of primary keypoint: head, pelvis, or spine. Example Multi-HMR methods appear robust to this choice, though using the head as primary keypoint yielded best results by a small margin. Additional experiments kept the head as primary keypoint, also because it is the most often visible.

Camera embedding: Experiments demonstrated that integrating camera information can improve accuracy when recovering and placing human 3D meshes in the scene. FIG. 9(b) shows results with different kinds of camera embeddings; computing simple embedding (the normalized camera intrinsics are directly embedded into each patch) degraded performances compared to not adding camera embedding (i.e. none), while adding ray directions for each patch (denoted by rays) brought a gain. When combined with focal length normalization f (normalizing the depth by a certain focal length), a clear gain in prediction accuracy was observed on all metrics. FIG. 8, left, further illustrates that conditioning the model on camera intrinsics can also improve depth prediction accuracy.

Losses: Experiments considered different combinations of reconstruction losses: directly on the SMPL-X parameters (rot), on the vertices produced by the SMPL-X model (v3d), a combination of both (rot+v3d), and the addition of reprojection losses (+v2d). FIG. 9(c) shows that adding as much supervision as possible (in 3D, 2D and rotation space) yielded the best performance, possibly because it reduced ambiguities during training.

Data: FIG. 9(d) shows results of experiments with Real-world datasets (MS-COCO (Lin et al., Microsoft coco: Common objects in context. In ECCV, 2014), MPII (Andriluka et al., 2D human pose estimation: New benchmark and state of the art analysis, In CVPR, 2014), and H3.6M (Ionescu et al., Human3.6M: Large scale datasets and predictive methods for 3D human sensing in natural environments, IEEE trans. PAMI, 2013), for which pseudo-ground-truth fits are obtained by minimizing the reprojection error of annotated keypoints and with Synthetic datasets, namely BEDLAM and AGORA as well as a synthetic dataset generated using example methods herein (†). In both cases experiments were conducted with the SMPL and SMPL-X body models.

Multi-HMR methods matched the state of the art with real images using images with pseudo-ground-truth (Moon et al., Neuralannot: Neural annotator for 3d human mesh training sets, In CVPR Workshop, 2022; and Moon et al., Three recipes for better 3d pseudogts of 3d human mesh estimation in the wild; In CVPR Workshop, 2023.) on both body-only and whole-body benchmarks, though performance did degrade when using SMPL-X, which may be due to the lack of accuracy for small body parts (hands, faces) in the fits used as ground-truth for training. Performance improved significantly when using synthetic data, demonstrating that perfect 3D annotations are useful for accurate and robust predictions, in particular when considering faces and hands. It has previously been disclosed (e.g., Black et al., BEDLAM: A synthetic dataset of bodies exhibiting detailed lifelike animated motion, In CVPR, 2023) that training with large-scale synthetic data only is better than training with pseudo-fits acquired by minimizing reprojection of 2D keypoints on real images.

Experiments also evaluated the example synthetic booster dataset, containing people close to the camera and with diverse hand poses. Since current synthetic datasets such as BEDLAM and AGORA do not consider people close to the camera, images were generated following this particular setting. Adding this data to the training set significantly improved performance on whole-body mesh recovery, due to improved predictions on expressive body parts (hands and faces).

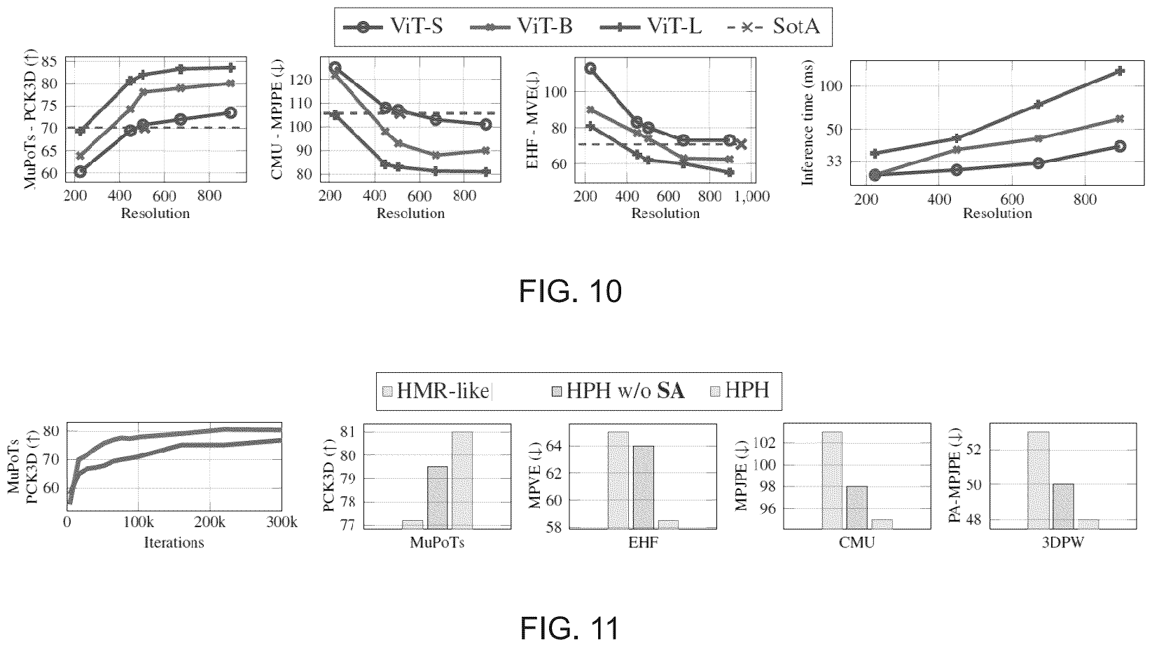

Input resolution and backbone: Additional experiments empirically evaluated the impact of the input image resolution on the final performance, for different backbone sizes (ViT-S, ViT-B, ViT-L), and results are shown in FIG. 10. Increasing the input resolution consistently provided performance gains across backbone sizes, though at the cost of increased inference time (right). A ViT-L backbone at 448×448 inputs arguably offers a good performance versus speed trade-off for body-only metrics, while using higher resolutions can be more worthwhile for whole-body metrics.

Further experiments were conducted with different pre-training methods, in which DinoV2 outperformed the others. The largest backbone (ViT-L) at a 896×896 resolution took approximately 120 ms to forward propagate—without compressing or quantizing the network—which is fast compared to multi-stage methods. For applications requiring real-time inference (30 FPS), a ViT-S combined with an image resolution of 672 provided optimal performance and already matched or surpassed the state of the art.

Head. FIG. 11 shows a comparison of different perception heads to regress the SMPL-X parameters. The baseline ‘HMR-like’ uses a vanilla iterative regressor (Kolotouros et al., Learning to reconstruct 3d human pose and shape via model-fitting in the loop, In ICCV, 2019) applied to each detected feature token independently. ‘HPH’ converged faster (left) and performed better (right). ‘HPH w/o SA’ denotes a variant where queries are treated independently by removing SA blocks from the HPH (e.g., Equation (5)). It was demonstrated that treating queries together was beneficial (FIG. 11, right).

### Synthetic Dataset Generation

Existing synthetic datasets, such as BEDLAM and AGORA, can provide perfect ground truths for the SMPL-X model, including faces and hands. However, in these datasets, most humans are seen from afar, which is not ideal to capture subtle details needed to properly reconstruct faces and hands. Further, the hand poses lack diversity. As example 3D recovery methods may be single-shot, i.e., run without specific image crops or feature resampling around hands, hands may consist of only a few visible pixels for many training images. As described above, example training methods can be further improved by supplementing the training data with a dedicated, booster dataset, which includes close-up pictures of single humans with clearly visible hands (or other expressive body parts) in diverse poses.

3D Human Models: An example method for generating a synthetic dataset renders images of 3D human models. Following the strategy of BEDLAM (Black et al., BEDLAM: A synthetic dataset of bodies exhibiting detailed lifelike animated motion, In CVPR, 2023), a procedural generation pipeline may be used with fine control over parameters, rather than commercially available scans of clothed humans (e.g., as in AGORA). Example methods employ a human generator such as HumGen3D (https://www.humgen3d.com), which is an open-source human generator add-on to the Blender software tool. Such an add-on can generate 3D rigged human models, with different clothing (layered on top of the body mesh), hairstyles, skin tones, age, etc. This yields a high diversity of humans overall.

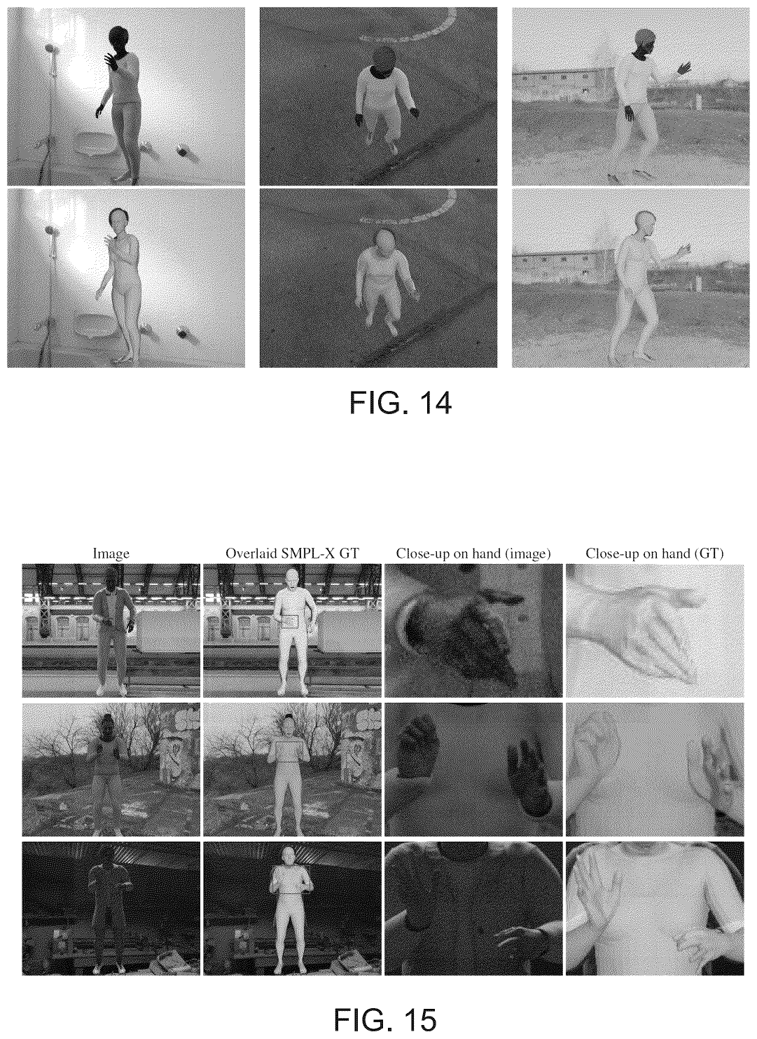

Retargeting with SMPL-X: To provide precisely annotated images, an example method manually defines pointwise correspondences between the SMPL-X and the HumGen3D meshes. For a given set of SMPL-X parameters as input, an example method iteratively optimizes the skeleton parameters of the HumGen3D model, which control the corresponding mesh through linear blend skinning, to minimize the distance between keypoints of both meshes. FIG. 14 shows examples of rendered avatars and their associated SMPL-X meshes and allows verifying of the quality of the retargeting.

Rendering: Characters may be placed into empty scenes so as to take up, for instance, a majority or most of the space in the camera plane with random HDRIs images taken, for instance, from Poly Haven (https://polyhaven.com/) as environment maps. An example method uses a focal of 843 pixels and renders images with resolution 900×675. The principal point is set at the center of the image.

Human shape sources and hand diversity: A goal of example synthetic dataset generation methods is to generate humans that are: i) close to the camera such that the hands are sufficiently visible, and ii) with diverse hand poses. For the first point i), an example method renders images of a single person, facing the camera, at a distance varying slightly around 2.5 meters, which was found to yield visible hands.

For the second point ii), human poses are sampled from BEDLAM, AGORA, and UBody, where hand annotations are respectively: taken from the GRAB dataset (Taheri et al., GRAB: A dataset of whole-body human grasping of objects, In ECCV, 2020), fitted to 3D scans, and fitted to in-the-wild images. In addition to these three example sources, in order to further diversify the generated set of hand poses, UBody's annotations are further augmented with hands from other sources. For example, a large set of diverse hand poses are created using MANO annotations from the InterHand dataset (Moon et al., Interhand2. 6m: A dataset and baseline for 3d interacting hand pose estimation from a single rgb image, In ECCV, 2020). This can be done by extracting all MANO annotations and transforming hands into right-hand format. When creating a synthetic image with augmented hands, an example method samples two random hands from the large set, transforms one into a left hand, and replaces hands from the chosen SMPL-X annotations using the new hand poses. This can provide an even richer set of hands than the original InterHand annotations, in that left hands can be turned into right hands, which increases the number of possible combinations.

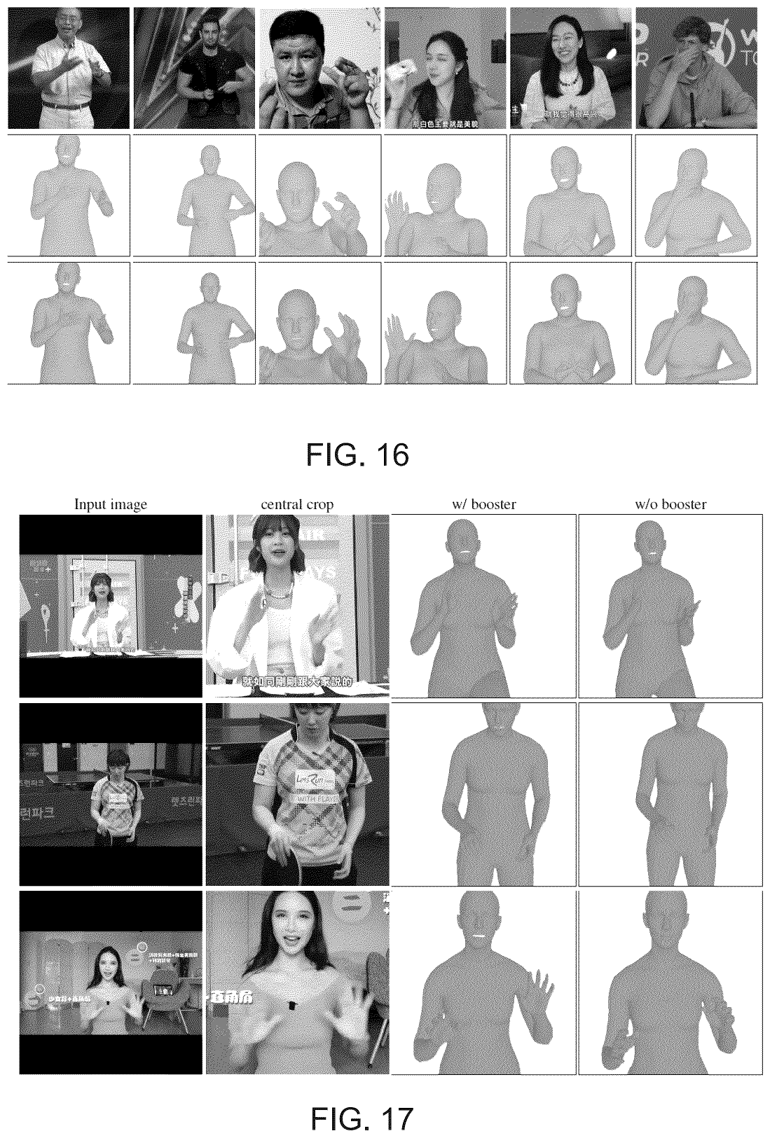

Dataset: An example method generated about 73 k images, equally spread with human shapes from i) BEDLAM, ii) AGORA, iii) UBody, iv) UBody with increased hand diversity. FIGS. 14-15 show qualitative examples of generated images and the associated SMPL-X mesh. FIG. 15 shows examples from a synthetic booster dataset showing the input image, the overlaid SMPL-X annotations, the close-up image, and annotations around the hands corresponding to the rectangle shown in the second column. People are seen up close, and diverse hand poses are used. FIG. 16 shows examples of hand swapped shapes, illustrating increasing hand diversity in human shape sources to be rendered. Given an annotation from UBody (image on top, annotation in the middle row), an example method swaps the hands from a large set built from InterHand to have more diversity in terms of hand poses.

Adding example synthetic datasets can provide both qualitative and quantitative benefits. For example, as shown in FIG. 17, the hands are significantly better predicted when the training set includes the synthetic booster dataset.

### Additional Ablation Experiments

Additional ablation experiments were conducted regarding i) ablations on the architecture of the example Human Perception Head (HPH) module, ii) ablations on the type of pretraining used to initialize the backbone for Multi-HMR, and iii) results on all benchmarks obtained with a universal model, without any dataset-specific finetuning.

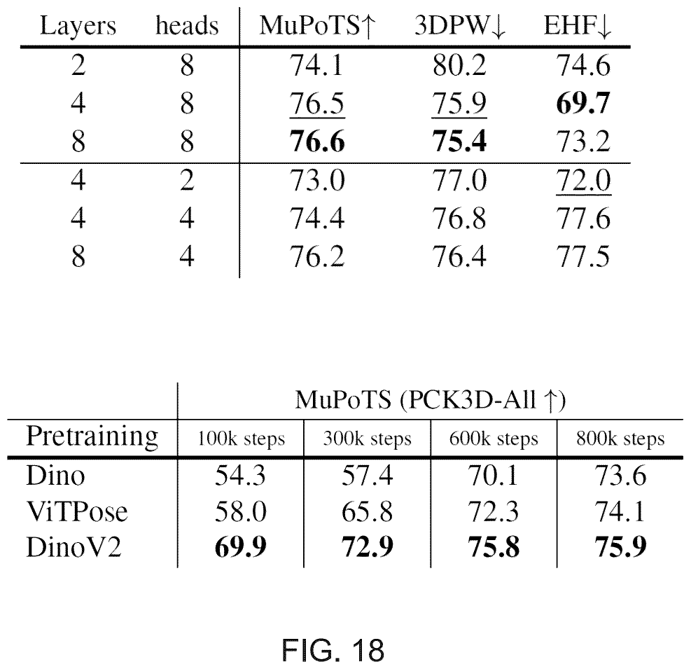

Ablation HPH: FIG. 18 (top) shows results of experiments with different configurations for the HPH module, using a ViT-Base architecture as backbone and images of resolution 448×448 as input. Results were reported after 500 training steps. As the HPH module is based on cross-attention layers, the main parameters are the number of layers and the number of heads used. It was observed that increasing the number of layers and the number of heads leads to performance improvements, though at the cost of increased training and inference times (with a diminishing return). Further experiments kept a simple setting as default, with 2 layers and 8 attention heads.

Backbone: FIG. 18 (bottom) shows results using various pretraining methods, with a ViT-Base architecture and 448×448 input images. Dino (Caron et al., Emerging properties in self-supervised vision transformers, In ICCV, 2021) and DinoV2 (Oquab et al., Dinov2: Learning robust visual features without supervision. arXiv preprint arXiv: 2304.07193, 2023) rely on self-supervised pre-training, while ViTPose is trained with 2D body keypoints supervision. It was observed that DinoV2 led to the best final performance and converged faster. The difference in performance decreased with time, which may be due to the relatively large size of the example training set, with ViTPose eventually achieving comparable results. Using DinoV2 may be most beneficial when training computation is limited.

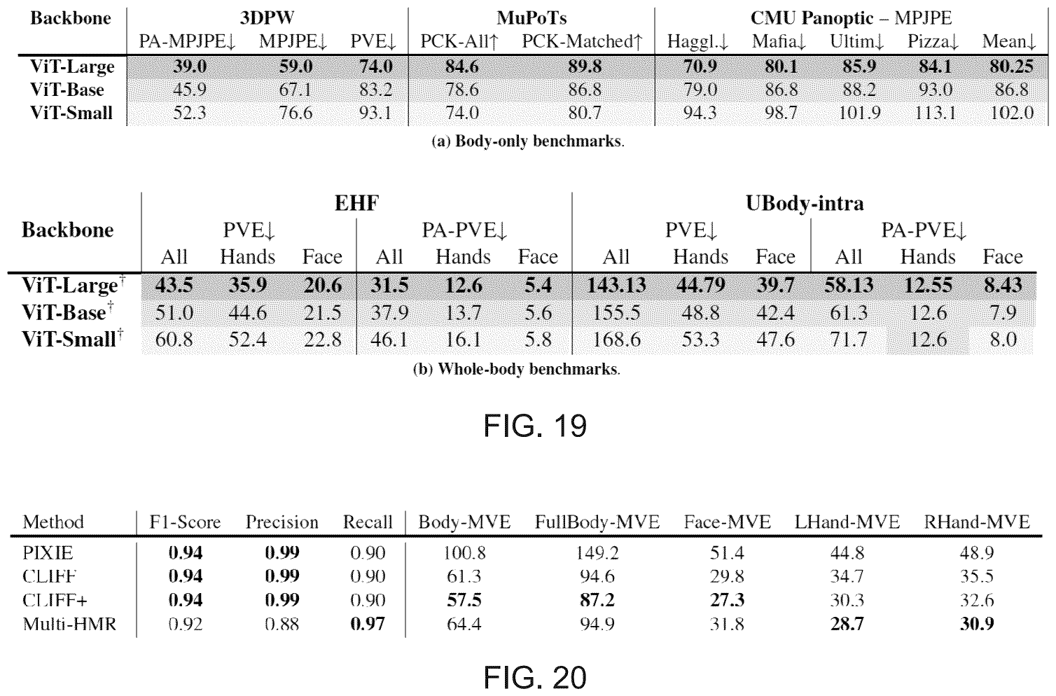

Universal model: FIG. 19 shows additional experimental results obtained with a single checkpoint shared for all benchmarks, without finetuning on any specific dataset. Results are reported at input resolution 896×896, for ViT-Small, ViT-Base and ViT-Large backbones, and models were trained simultaneously on AGORA, BEDLAM, 3DPW and an example synthetic booster dataset. Results demonstrated that finetuning was useful to achieve optimal performance on this dataset with Multi-HMR and large backbones. Including 3DPW in the training from the start improved results further compared to simple finetuning. Further, it was demonstrated that performance on MuPoTS, CMU and EHF was maintained or improved. For all benchmarks except Ubody, example universal Multi-HMR models could achieve state-of-the-art performance with a single checkpoint, even without fine-tuning.

Results on BEDLAM-test: FIG. 20 shows results on BEDLAM-test using a recently released online leaderboard, demonstrating that example Multi-HMR methods achieve competitive performances on this dataset.

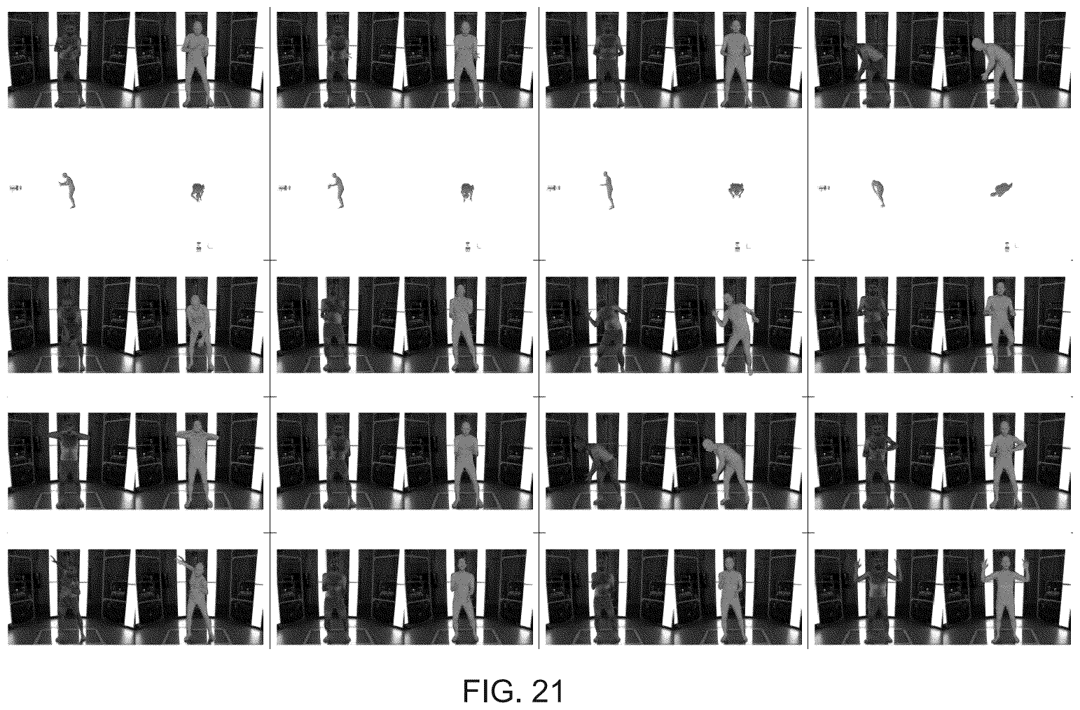

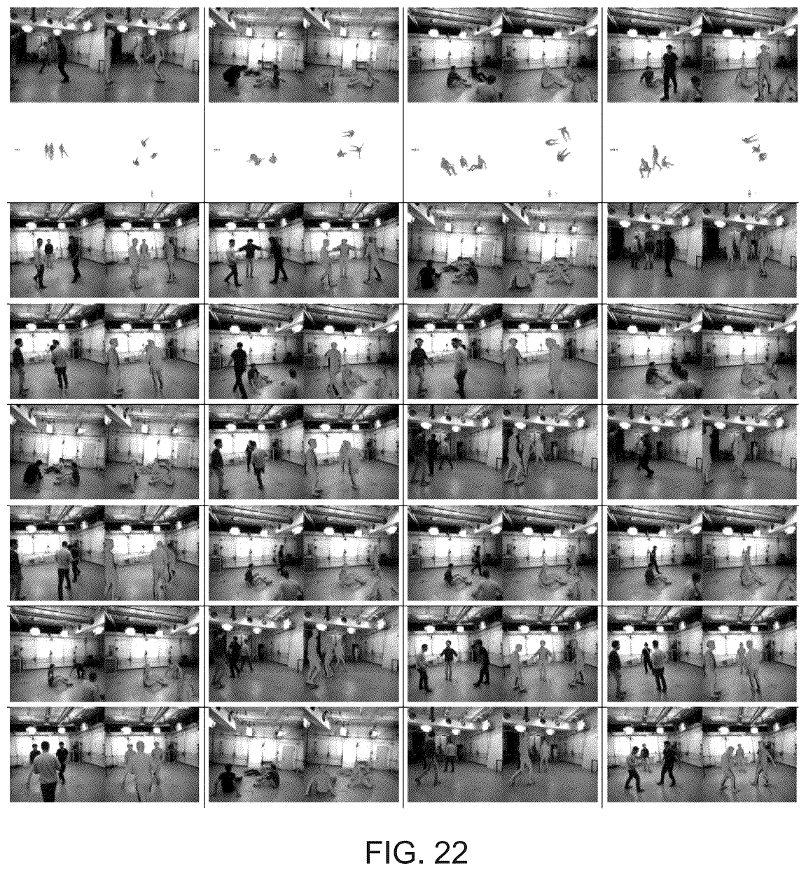

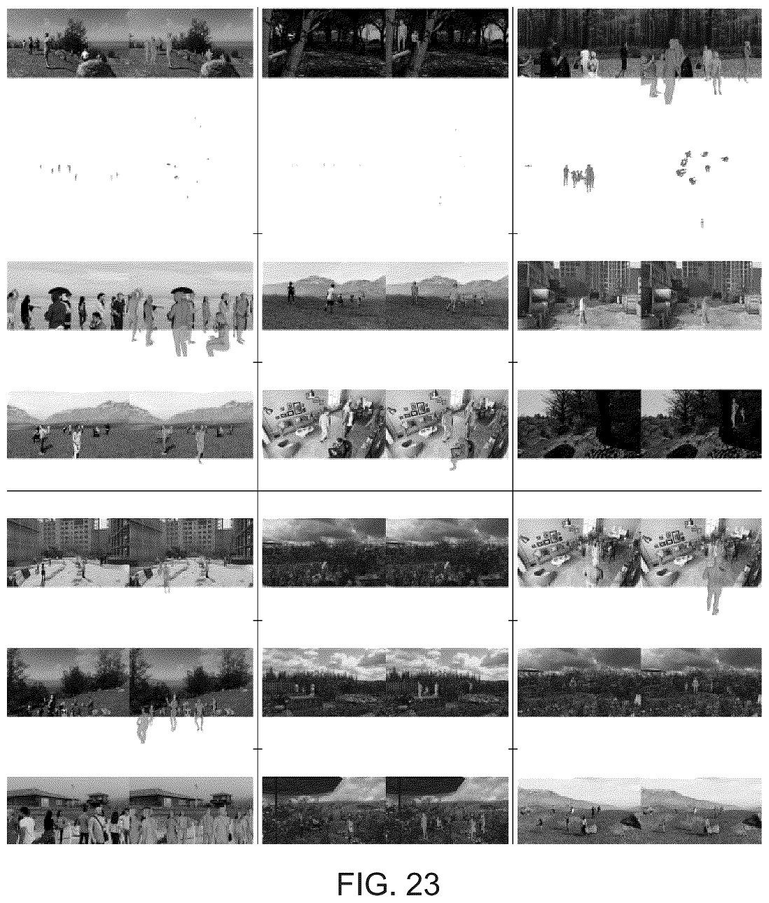

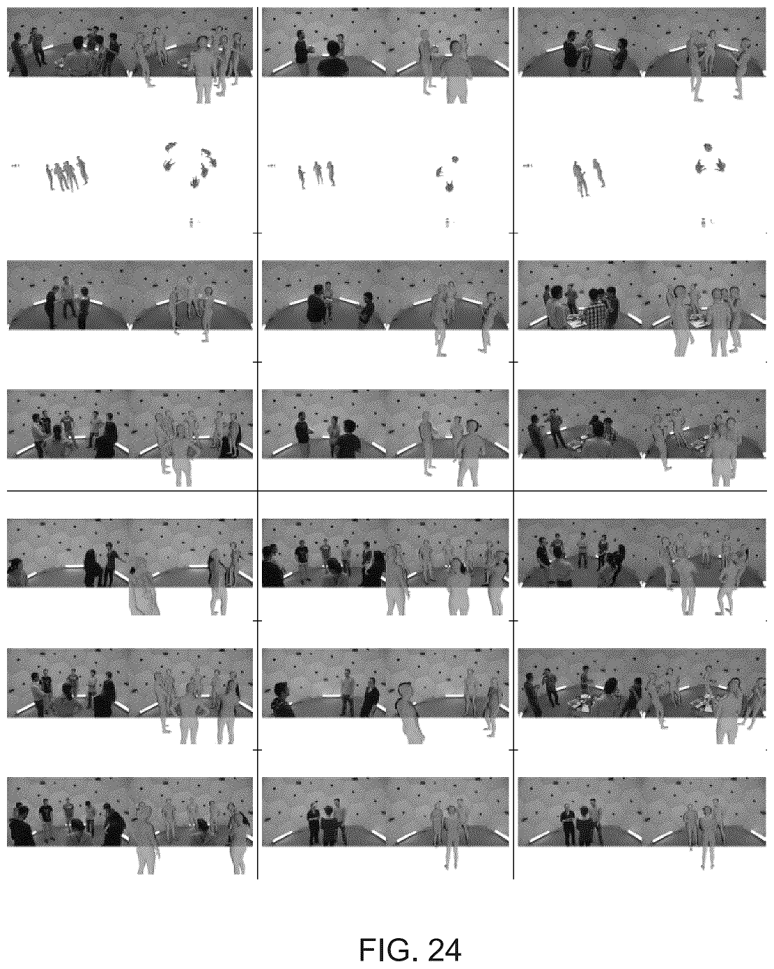

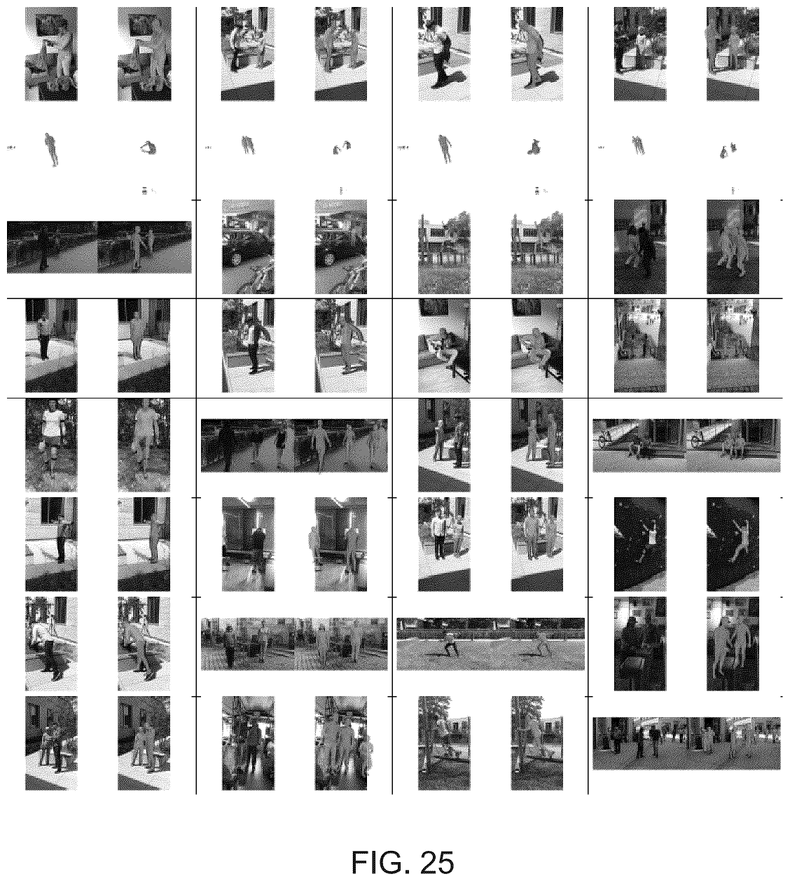

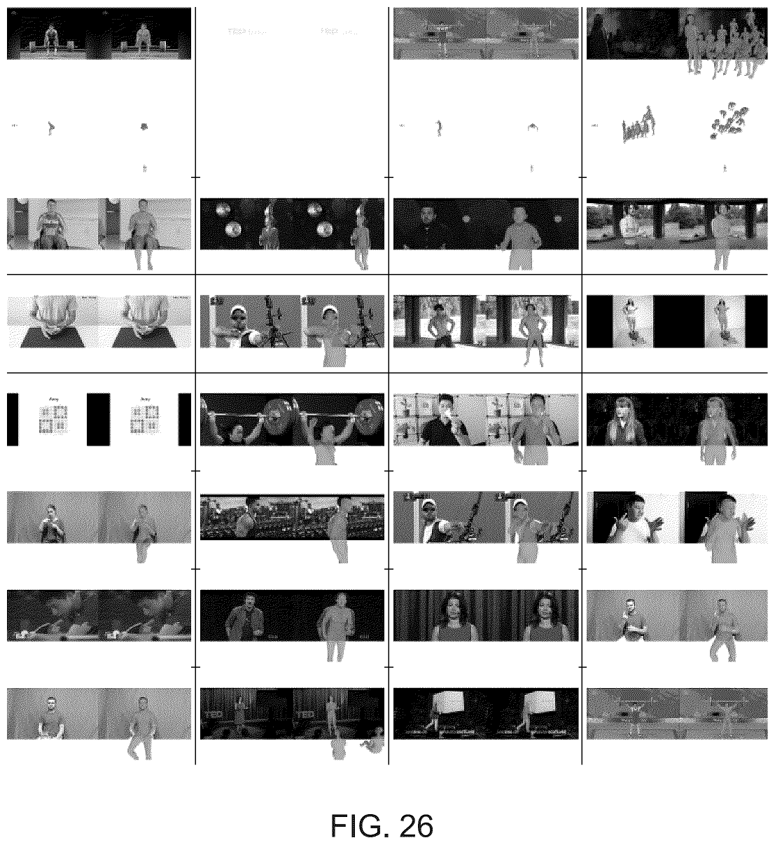

Visualization on validation/test images: FIGS. 21-26 illustrate randomly selected images from the various test and validation datasets used in example Multi-HMR experiments, namely EHF (FIG. 21), MuPoTS (FIG. 22), AGORA (FIG. 23, CMU panoptics (FIG. 24), 3DPW (FIG. 25), and UBody (FIG. 26). The figures were automatically generated after randomly shuffling the datasets. Together, these datasets offer a large variety in terms of poses, backgrounds, viewpoints, ethnicity, group size and density, distance to the camera, and expressivity of the hands and faces. Qualitatively, the predictions displayed (both reprojections in the image plane as well as Bird-eye views) show that example Multi-HMR methods provided overall accurate predictions across all settings.

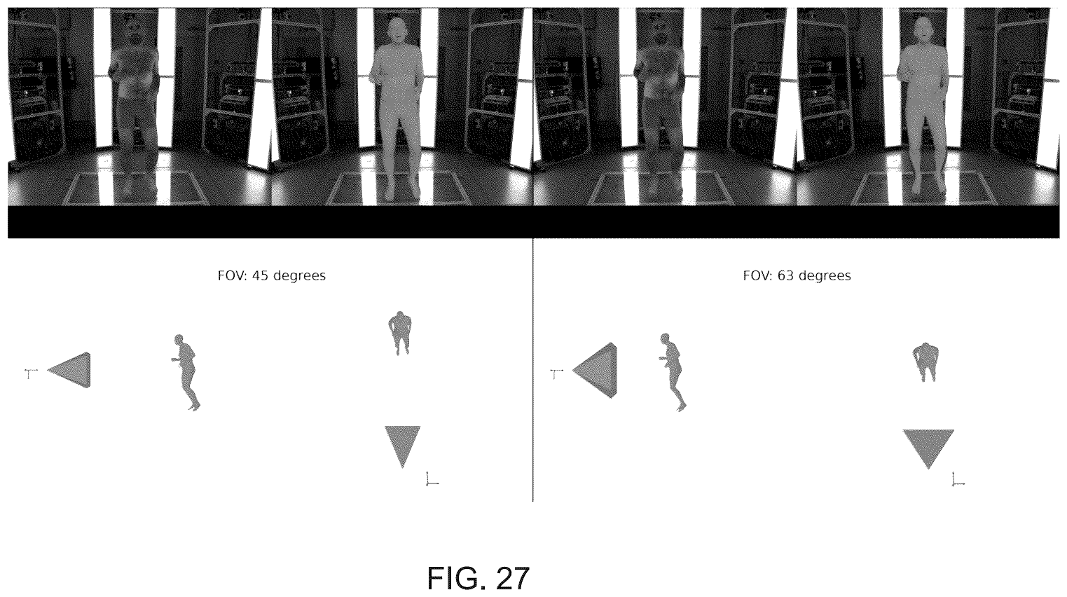

Impact of focal length: The impact of the input camera parameters for an example Multi-HMR model was investigated by varying the focal length given as input. To do so experiments kept the same image but artificially changed the value of the focal length given as input to Multi-HMR and visualized the reconstructed mesh, as illustrated in FIG. 27. It was observed that the example Multi-HMR model adapted the shape and the distance of humans in the 3D scene such that the re-projection in the image plane remains consistent. This validates the fact that camera parameters are taken into account by the example Multi-HMR model.

Robustness to occlusion: Further experiments produced synthetic occlusion by adding a grey square in the input image and visualize the 3D reconstruction done by Multi-HMR. Example models consistently produced plausible predictions and the overall 3D reconstruction still remained of very good quality. For instance, by pausing video when grey squares covered the hands one can observe that the model predicts wrong but coherent hand pauses when the hands are occluded.

### Other Example Applications

Example 3D recovery models such as Multi-HMR models have various applications. For instance, in virtual or augmented reality (VR/AR), mixed reality (MR), or so-called spatial computing applications, capturing features such as faces and hands more precisely is highly useful, as it is a significant component of common human communication. Capturing such features is also beneficial for further enabling interaction between humans and autonomous devices such as robots. It can also be beneficial for human understanding from media such as images or videos. Likewise, understanding the placement of people in a scene is useful for applications ranging from robotic navigation to VR/AR/MR/spatial computing applications involving multiple people. Efficient processing of a variable number of people is desirable when computation capacity is restricted and/or when real-time processing is needed. Further, adaptability to camera information, when known, can improve reasoning about 3D meshes. In some specific applications, such 3D recovery models may be used for enabling (i) robot navigation in confined and crowded spaces such as elevators, and/or (ii) data annotation or animation as part of a workflow that first identifies people within a scene and then allows for the annotation of or animation using recovered 3D meshes.

### Network and Hardware Architecture

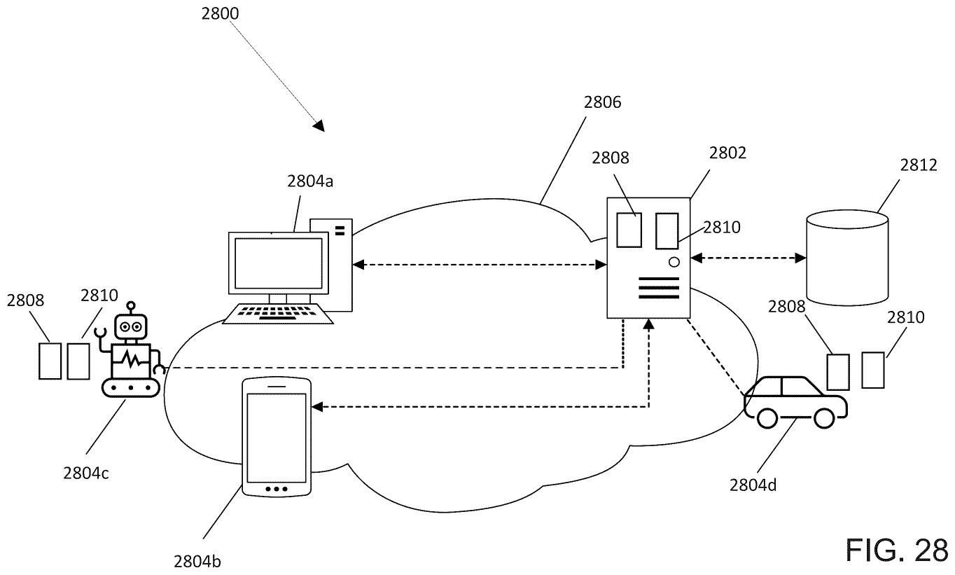

Example systems, methods, and embodiments may be implemented within an architecture 2800 or a portion thereof such as illustrated in FIG. 28. The architecture 2800 may comprise a server 2802 and/or may comprise one or more devices such as devices 2804. The devices 2804 may operate as client devices and may communicate directly and/or over a network 2806 which may be wireless and/or wired, such as the Internet, for data exchange, or may operate as standalone devices (or even disconnected from the server 2802 entirely).

The server 2802 and the devices 2804 can each include a processor, e.g., processor 2808, and a memory, e.g., memory, such as but not limited to random-access memory (RAM), read-only memory (ROM), hard disks, solid state disks, or other non-volatile storage media. Memory 2810 may also be provided in whole or in part by external storage in communication with the processor 2808.

The system 100 or 300, for instance, may be provided in the server 2802 and/or one or more of the devices 2804. In some example embodiments, the system 100, 300 is provided in the devices 2804, possibly without the training module 130, and/or the training module 130 is provided in the devices 2804 and/or the server 2802. In other example embodiments, the server 2802 trains the system 100, 300 or pretrains the system offline, and the architecture is then provided in the devices, or the system may be integrated into the devices and end-to-end trained.

It will be appreciated that the processor 2808 in the server 2802 or any of the devices 2804 can include either a single processor or multiple processors operating in series or in parallel, and that the memory 2810 in the server 2802 or any of the devices 2804 can include one or more memories, including combinations of memory types and/or locations. Server 2802 may also include, but are not limited to, dedicated servers, cloud-based servers, or a combination (e.g., shared). Storage, e.g., a database, may be embodied in suitable storage in the server 2802, device 2804, a connected remote storage 2812 (shown in connection with the server 2802, but can likewise be connected to client devices), or any combination.

Devices 2804 may be any processor-based device, terminal, etc., and/or may be embodied in an application executable by a processor-based device, etc. Example devices include, but are not limited to, autonomous devices, media or display devices, or interactive devices. Devices 2804 may operate as clients and be disposed within the server 2802 and/or external to the server (local or remote, or any combination) and in communication with the server, or may operate as standalone devices, or a combination.

Example devices 2804 include, but are not limited to, autonomous computers 2804a, mobile communication devices (e.g., smartphones, tablet computers, etc.) 2804b, robots 2804c, autonomous vehicles 2804d, wearable devices, virtual reality, augmented reality, or mixed reality devices (not shown), or others. Devices 2804 communicating with the server 2802 may be configured for sending data to and/or receiving data from the server, while other devices 2804 may be standalone devices. Devices may include, but need not include, one or more input devices, such as image capturing devices, and/or output devices, such as for communicating, e.g., transmitting, actions determined through navigation methods. Devices may include combinations of client devices.

In example training methods, the server 2802 or devices 2804 may receive a dataset from any suitable source, e.g., from a memory 2810 (as nonlimiting examples, internal storage, an internal database, etc.), from external (e.g., remote) storage 2812 connected locally or over the network 2806. For 3D mesh recovery training, devices 2804 may receive datasets including images, possibly including synthetic datasets, which may but need not include synthetic booster datasets as provided herein. The example training methods can generate a trained model or portion thereof that can be likewise stored in the server (e.g., memory 2810), devices 2804, external storage 2812, or combination. In some example embodiments provided herein, training may be performed offline or online (e.g., at run time), in any combination.

The example system 100 shown in FIG. 1 or portions thereof may be incorporated into a device such as an autonomous apparatus (e.g., vehicle 2804d or robot 2804c), interactive device, AR/VR/MR device, a computer, etc. The system 100 may comprise an image-capturing device such as a camera 102 having camera intrinsics. The camera 102 can generate a (for example) 2D image of a scene for input into the example 3D mesh recovery model.

An example device, such as but not limited to an autonomous device, alone or via communication with another device 2804 or server 2802, may train, e.g., using training module 130, a system 100 embodied in a machine learning model for a downstream task. Alternatively, the device may receive from the server 2802 a trained system trained by the server, e.g., using training module 130 (or similar model for system 100) or by another device. Models may be updated or fine-tuned. Updated models including model parameters may be stored in memory 2810.

The device may apply the trained machine learning model to receive one or more images obtained from the camera 102 as needed to generate whole-body multi-human 3D meshes. The device may then adapt its display, e.g., display 124, or other interface, and/or adapt its motion state (e.g., velocity or direction of motion) or other actuating operation based on the generated 3D meshes. For example, the controller 126 may be configured to control operation of the actuator 128, e.g., a propulsion device, to navigate the autonomous apparatus to perform a downstream task. As another example, the device may generate enhanced images, e.g., of 3D scenes, including generated 3D meshes. The enhanced images may be displayed and/or stored, e.g., as media such as images and/or video, and/or may be further processed using one or more downstream methods.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

Embodiments herein provide, among other things, a computer-implemented method for recovering a three-dimensional (3D) mesh of N humans in a 3D scene, the method comprising: receiving a two-dimensional (2D) image of the scene from an image capturing device, the 2D image including a plurality of regions; by one or more processors, encoding the received image to extract embedded features for each of the plurality of regions; by one or more processors, detecting N humans in N respective regions among the plurality of regions; by one or more processors, processing the embedded features in the N respective regions and the embedded features for each of the plurality of regions to predict body model and depth parameters for each of the N detected humans, wherein the processing uses a decoder comprising a cross-attention module; providing the predicted body model parameters for each of the N detected humans to a 3D parametric model for generating N 3D meshes; and placing each of the N generated meshes at a respective 3D spatial location in the 3D scene based on the predicted depth parameters. In addition to any of the above features in this paragraph, N may be greater than one, the body model parameters may comprise pose and shape parameters, and each generated 3D mesh may be a whole-body mesh. In addition to any of the above features in this paragraph, processing the embedded features for each of the detected N humans may comprise: generating a query from the embedded features for each of the N respective regions to provide N generated cross-attention queries; and inputting the N generated cross-attention queries and the embedded features for each of the plurality of regions into the cross-attention module, wherein the embedded features for each of the plurality of regions provide cross-attention keys and values for the cross-attention module. In addition to any of the above features in this paragraph, the decoder may comprise a transformer model, and the cross-attention module may generate updated queries. In addition to any of the above features in this paragraph, processing the embedded features for each of the detected N humans may further comprise: further updating the updated queries using a self-attention module; and regressing the body model and depth parameters from the updated or further updated queries; wherein regressing the body model and depth parameters from the updated queries may use respective multi-layer perceptrons (MLPs). In addition to any of the above features in this paragraph, generating a query may further comprise (i) combining the embedded features for each of the N respective regions with a learned query initialization based on a 2D position, and/or (ii) combining the embedded features for each of the N respective regions with mean body model parameters. In addition to any of the above features in this paragraph, receiving a two-dimensional (2D) image of the scene from the image capturing device may further comprise receiving intrinsic parameters of the image capturing device, and the 2D image may include a plurality of regions. In addition to any of the above features in this paragraph, encoding the received image to extract embedded features for each of the plurality of regions may further comprise encoding the intrinsic parameters of the image capturing device. In addition to any of the above features in this paragraph, the method may further comprise, before processing the embedded features for each of the detected N humans, concatenating embedded features for each of the plurality of regions with intrinsic parameters of the image capturing device. In addition to any of the above features in this paragraph, the intrinsic parameters may comprise embedded values of ray directions from a center of each of the plurality of regions. In addition to any of the above features in this paragraph, the embedded values may be generated using Fourier encoding. In addition to any of the above features in this paragraph, each region may comprise a 2D patch. In addition to any of the above features in this paragraph, the plurality of regions may define a grid of patches forming the 2D image. In addition to any of the above features in this paragraph, detecting N humans may comprise detecting a primary keypoint in each of the N respective regions; wherein each generated 3D mesh may be centered around the primary keypoint. In addition to any of the above features in this paragraph, each of the primary keypoints may comprise a human head, torso, midsection, spine, or pelvis. In addition to any of the above features in this paragraph, detecting a primary keypoint may comprise: generating, for each of the plurality of regions, a probability that the primary keypoint is present within the region; and determining that the primary keypoint is present by comparing the generated probability to a threshold. In addition to any of the above features in this paragraph, the generated probabilities for each of the plurality of regions may define a 2D heatmap. In addition to any of the above features in this paragraph, the method may further comprise, for each of the N primary keypoints, determining a 2D location of the primary keypoint within the respective region. In addition to any of the above features in this paragraph, for each of the N primary keypoints, determining a location of the primary keypoint within the respective region may comprise regressing an offset from a center of the respective region. In addition to any of the above features in this paragraph, generating a 3D mesh at a 3D spatial location for each of the N detected humans in the 3D scene may comprise: for each generated 3D mesh generated by the 3D parametric model, determining the 3D spatial location based on the determined 2D location of the primary keypoint and the predicted depth; and placing the generated 3D mesh at the determined 3D spatial location in the scene; wherein the 3D spatial location may be in camera space. In addition to any of the above features in this paragraph, the extracted embedded features may comprise a feature tensor comprising a plurality of feature tokens, each feature token respectively corresponding to each of the plurality of regions and having a feature dimension. In addition to any of the above features in this paragraph, each generated 3D mesh may be an expressive human pose. In addition to any of the above features in this paragraph, each generated 3D mesh may comprise human faces, hands, and feet. In addition to any of the above features in this paragraph, the 3D parametric model may comprise a SMPL-X model. In addition to any of the above features in this paragraph, encoding the received image may use a Vision Transformer. In addition to any of the above features in this paragraph, the computer-implemented method may be implemented by a neural model. In addition to any of the above features in this paragraph, the neural model may be trained using a dataset comprising a synthetic dataset; wherein the synthetic dataset comprises a generated plurality of images. In addition to any of the above features in this paragraph, each of the generated plurality of images may include a single human having visible hands positioned in a hand pose; and among the generated plurality of images, the hand poses may be diverse. In addition to any of the above features in this paragraph, the synthetic dataset may be a supplement to a dataset including ground truths for the 3D parametric model. In addition to any of the above features in this paragraph, for each generated 3D mesh, the output parameters for generating each 3D mesh may have a dimension that is lower than a dimension of each generated 3D mesh. In addition to any of the above features in this paragraph, the method may further comprise: storing each generated 3D mesh; and performing a downstream task using each generated 3D mesh. In addition to any of the above features in this paragraph, the downstream task may comprise one or more of: generating a virtual 3D avatar; operating a virtual 3D avatar; controlling movement of an autonomous device; performing collision avoidance between a human and an autonomous device based on the generated 3D meshes; performing an interaction between a human and an autonomous device; and/or predicting a response to an interaction between a human and an autonomous device based on the generated 3D meshes. In addition to any of the above features in this paragraph, the computer-implemented method may be implemented by a neural model; wherein the neural model may be end-to-end trained using a loss comprising a human detection loss and at least one regression loss; wherein the detection loss may comprise a cross-entropy loss; and wherein the at least one regression loss may comprise one or more of a parameters loss, an image plane reprojection loss, or a loss for human-centered output meshes.

Additional embodiments provide, among other things, a system for recovering a three-dimensional (3D) mesh of N humans in a 3D scene, comprising: a processor and memory coupled to the processor, the memory including instructions executable by the processor implementing: an image encoder configured to receive a two-dimensional (2D) image of the scene including a plurality of regions from an image capturing device and encoding the received image to extract embedded features for each of the plurality of regions; a detector configured to detect N humans at 2D locations in N respective regions among the plurality of regions in the encoded image; a decoder configured to process the embedded features in the N respective regions and the embedded features for each of the plurality of regions to predict body model and depth parameters for each of the N detected humans, the decoder comprising a cross-attention module; a 3D parametric model configured to receive the predicted body model parameters for each of N detected humans and generate N 3D meshes; and a mesh positioning module configured to place each of the generated N 3D meshes at a respective 3D spatial location in the 3D scene based on the predicted depth parameters and the 2D locations. In addition to any of the above features in this paragraph, N may be greater than one. In addition to any of the above features in this paragraph, the body model parameters may comprise pose and shape parameters. In addition to any of the above features in this paragraph, the 3D mesh may be a whole-body mesh. In addition to any of the above features in this paragraph, the decoder may be configured to generate a query from the embedded features for each of the N respective regions to provide N generated cross-attention queries and input the N generated cross-attention queries and the embedded features for each of the plurality of regions into the cross-attention module; and the embedded features for each of the plurality of regions may provide cross-attention keys and values for the cross-attention module. In addition to any of the above features in this paragraph, the cross-attention module may generate updated queries. In addition to any of the above features in this paragraph, the decoder may comprise a transformer model. In addition to any of the above features in this paragraph, the decoder may further comprise a self-attention module for further updating the queries. In addition to any of the above features in this paragraph, the decoder may further comprise a multi-layer perceptron (MLP) configured to regress the body model and depth parameters from the updated queries. In addition to any of the above features in this paragraph, the system may further comprise: a camera intrinsics encoder configured to embed intrinsic parameters of the image capturing device. In addition to any of the above features in this paragraph, the embedded intrinsic parameters may be concatenated with the embedded features for each of the plurality of regions upstream of the decoder. In addition to any of the above features in this paragraph, the intrinsic parameters may comprise embedded values of ray directions from a center of each of the plurality of regions. In addition to any of the above features in this paragraph, the camera intrinsics encoder may comprise a Fourier encoder. In addition to any of the above features in this paragraph, each region may comprise a 2D patch, and the plurality of regions may define a grid of patches forming the 2D image. In addition to any of the above features in this paragraph, the detector may be configured to detect a primary keypoint in each of the N respective regions; wherein each generated 3D mesh may be centered around the primary keypoint. In addition to any of the above features in this paragraph, each of the primary keypoints may comprise a human head, torso, midsection, spine, or pelvis. In addition to any of the above features in this paragraph, the detector may be configured to generate, for each of the plurality of regions, a probability that the primary keypoint is present within the region. In addition to any of the above features in this paragraph, the detector may determine that the primary keypoint is present by comparing the generated probability to a threshold. In addition to any of the above features in this paragraph, the detector may be further configured to determine a location of each of the N primary keypoints within their respective region by regressing an offset from a center of the respective region. In addition to any of the above features in this paragraph, the mesh positioning module may be configured to: for each generated 3D mesh, determine the 3D spatial location based on the determined location of the primary keypoint and the predicted depth; and place the generated 3D mesh at the determined 3D spatial location in the scene. In addition to any of the above features in this paragraph, the 3D spatial location may be in camera space. In addition to any of the above features in this paragraph, the image encoder may be configured to generate a feature tensor comprising a plurality of feature tokens. In addition to any of the above features in this paragraph, each feature token may respectively correspond to each of the plurality of regions and having a feature dimension. In addition to any of the above features in this paragraph, the 3D parametric model may comprise a SMPL-X model. In addition to any of the above features in this paragraph, the image encoder may comprise a Vision Transformer. In addition to any of the above features in this paragraph, the generated 3D meshes may comprise human faces, hands, and feet. In addition to any of the above features in this paragraph, the system may further comprise memory for storing the generated 3D meshes, and the instructions executable by the processor may further implement a controller for performing a downstream task using the generated 3D meshes. In addition to any of the above features in this paragraph, the system may further comprise an actuator coupled to the controller for actuating the autonomous device. In addition to any of the above features in this paragraph, the downstream task may comprise one or more of: controlling movement of an autonomous device using the actuator including collision avoidance based on the generated 3D meshes, and/or performing an interaction between a human and an autonomous device. In addition to any of the above features in this paragraph, the system may further comprise memory for storing the generated 3D meshes, wherein the instructions executable by the processor may further implement a controller for performing a downstream task using the generated 3D meshes. In addition to any of the above features in this paragraph, the system may further comprise an actuator coupled to the controller for actuating the autonomous device. In addition to any of the above features in this paragraph, the downstream task may comprise one or more of: generating a virtual 3D avatar; and/or operating a virtual 3D avatar; wherein the controller is coupled to a display for displaying a 3D avatar in an executed virtual reality or augmented reality application. In addition to any of the above features in this paragraph, the system may further comprise: an image capturing device comprising a camera; at least one image capturing device for obtaining the 2D image; wherein the instructions executable by the processor further implementing a downstream task control module that controls an operation of the image capturing device based on the generated 3D meshes; wherein the system may further comprise: an actuator controlled using the downstream task control module; and a display controlled using the downstream task control module.

Additional embodiments provide, among other things, a non-transitory computer-readable medium storing a program including instructions that, when executed by a processor, causes an information processing apparatus to recover a three-dimensional (3D) whole-body mesh of N humans in a 3D scene, where N is at least one, by: receiving a two-dimensional (2D) image of the scene from an image capturing device, the 2D image including a plurality of regions; by one or more processors, encoding the received image to extract embedded features for each of the plurality of regions; by one or more processors, detecting N humans in N respective regions among the plurality of regions; by one or more processors, processing the embedded features in the N respective regions and the embedded features for each of the plurality of regions to predict body model and depth parameters for each of the N detected humans, wherein the processing uses a decoder comprising a cross-attention module; providing the predicted body model parameters for each of the N detected humans to a 3D parametric model for generating N whole-body 3D meshes; and placing each of the N generated whole-body meshes at a respective 3D spatial location in the 3D scene based on the predicted depth parameters.

Additional embodiments provide, among other things, a computer-implemented method for recovering a three-dimensional (3D) mesh of N humans in a 3D scene, the method comprising: receiving a two-dimensional (2D) image of the scene from an image capturing device and intrinsic parameters of the image capturing device, the 2D image including a plurality of regions; by one or more processors, encoding the received image to extract embedded features for each of the plurality of regions and encoding the intrinsic parameters of the image capturing device; by one or more processors, detecting N humans in N respective regions among the plurality of regions; by one or more processors, processing the embedded features in the N respective regions and the embedded features for each of the plurality of regions to predict body model and depth parameters for each of the N detected humans, wherein the processing uses a decoder comprising a cross-attention module; providing the predicted body model parameters for each of the N detected humans to a 3D parametric model for generating N 3D meshes; and placing each of the N generated meshes at a respective 3D spatial location in the 3D scene based on the predicted depth parameters. In addition to any of the above features in this paragraph, N may be greater than one, the body model parameters may comprise pose and shape parameters, and each generated 3D mesh may be a whole-body mesh. In addition to any of the above features in this paragraph, processing the embedded features for each of the detected N humans may comprise: generating a query from the embedded features for each of the N respective regions to provide N generated cross-attention queries; and inputting the N generated cross-attention queries and the embedded features for each of the plurality of regions into the cross-attention module, wherein the embedded features for each of the plurality of regions provide cross-attention keys and values for the cross-attention module. In addition to any of the above features in this paragraph, the decoder may comprise a transformer model. In addition to any of the above features in this paragraph, the cross-attention module may generate updated queries. In addition to any of the above features in this paragraph, processing the embedded features for each of the detected N humans may further comprise further updating the updated queries using a self-attention module. In addition to any of the above features in this paragraph, processing the embedded features for each of the detected N humans may further comprise regressing the body model and depth parameters from the updated or further updated queries. In addition to any of the above features in this paragraph, regressing the body model and depth parameters from the updated queries may use respective multi-layer perceptrons (MLPs). In addition to any of the above features in this paragraph, generating a query may further comprise combining the embedded features for each of the N respective regions with a learned query initialization based on a 2D position. In addition to any of the above features in this paragraph, generating a query may further comprise combining the embedded features for each of the N respective regions with mean body model parameters. In addition to any of the above features in this paragraph, the method may further comprise, before processing the embedded features for each of the detected N humans, concatenating embedded features for each of the plurality of regions with intrinsic parameters of the image capturing device. In addition to any of the above features in this paragraph, the intrinsic parameters may comprise embedded values of ray directions from a center of each of the plurality of regions. In addition to any of the above features in this paragraph, the embedded values may be generated using Fourier encoding. In addition to any of the above features in this paragraph, each region may comprise a 2D patch, and the plurality of regions may define a grid of patches forming the 2D image. In addition to any of the above features in this paragraph, detecting N humans may comprise detecting a primary keypoint in each of the N respective regions; wherein each generated 3D mesh is centered around the primary keypoint. In addition to any of the above features in this paragraph, each of the primary keypoints may comprise a human head, torso, midsection, spine, or pelvis. In addition to any of the above features in this paragraph, detecting a primary keypoint may comprise: generating, for each of the plurality of regions, a probability that the primary keypoint is present within the region; and determining that the primary keypoint is present by comparing the generated probability to a threshold. In addition to any of the above features in this paragraph, the generated probabilities for each of the plurality of regions may define a 2D heatmap. In addition to any of the above features in this paragraph, the method may further comprise, for each of the N primary keypoints, determining a 2D location of the primary keypoint within the respective region. In addition to any of the above features in this paragraph, for each of the N primary keypoints, determining a location of the primary keypoint within the respective region may comprise regressing an offset from a center of the respective region. In addition to any of the above features in this paragraph, generating a 3D mesh at a 3D spatial location for each of the N detected humans in the 3D scene may comprise, for each generated 3D mesh generated by the 3D parametric model, determining the 3D spatial location based on the determined 2D location of the primary keypoint and the predicted depth; and placing the generated 3D mesh at the determined 3D spatial location in the scene. In addition to any of the above features in this paragraph, the 3D spatial location may be in camera space. In addition to any of the above features in this paragraph, the extracted embedded features may comprise a feature tensor comprising a plurality of feature tokens, each feature token respectively corresponding to each of the plurality of regions and having a feature dimension. In addition to any of the above features in this paragraph, the generated 3D mesh may be an expressive human pose. In addition to any of the above features in this paragraph, the 3D parametric model may comprise a SMPL-X model. In addition to any of the above features in this paragraph, encoding the received image may use a Vision Transformer. In addition to any of the above features in this paragraph, the generated 3D meshes may comprise human faces, hands, and feet. In addition to any of the above features in this paragraph, the computer-implemented method may be implemented by a neural model, wherein the neural model is trained using a dataset comprising a synthetic dataset, wherein the synthetic dataset comprises a generated plurality of images, each including a single human having visible hands positioned in a hand pose; and wherein among the generated plurality of images, the hand poses are diverse. In addition to any of the above features in this paragraph, the synthetic dataset may be a supplement to a dataset including ground truths for the 3D parametric model. In addition to any of the above features in this paragraph, for each generated 3D mesh, the output parameters for generating the 3D mesh may have a dimension that is lower than a dimension of the generated 3D mesh. In addition to any of the above features in this paragraph, the method may further comprise storing the generated 3D meshes. In addition to any of the above features in this paragraph, the method may further comprise performing a downstream task using the generated 3D meshes. In addition to any of the above features in this paragraph, the downstream task may comprise one or more of: generating a virtual 3D avatar, operating a virtual 3D avatar; controlling movement of an autonomous device, or performing an interaction between a human and an autonomous device. In addition to any of the above features in this paragraph, the downstream task may comprise controlling movement of an autonomous device including collision avoidance based on the generated 3D meshes. In addition to any of the above features in this paragraph, the downstream task may comprise performing an interaction between a human and an autonomous device including predicting a response to the interaction or an earlier interaction based on the generated 3D meshes. In addition to any of the above features in this paragraph, the downstream task may comprise generating or operating a 3D avatar in an executed virtual reality or augmented reality application. In addition to any of the above features in this paragraph, the computer-implemented method may be implemented by a neural model, wherein the neural model is end-to-end trained using a loss comprising a human detection loss and at least one regression loss. In addition to any of the above features in this paragraph, the detection loss may comprise a cross-entropy loss. In addition to any of the above features in this paragraph, the at least one regression loss may comprise one or more of a parameters loss, an image plane reprojection loss, or a loss for human-centered output meshes.

Additional embodiments may provide, among other things, a computer-implemented system for recovering a three-dimensional (3D) mesh of N humans in a 3D scene, the system comprising: a processor and memory coupled to the processor, the memory including instructions executable by the processor implementing: an image encoder configured to receive a two-dimensional (2D) image of the scene including a plurality of regions from an image capturing device and encoding the received image to extract embedded features for each of the plurality of regions; a detector configured to detect N humans at 2D locations in N respective regions among the plurality of regions in the encoded image; a decoder configured to process the embedded features in the N respective regions and the embedded features for each of the plurality of regions to predict body model and depth parameters for each of the N detected humans, the decoder comprising a cross-attention module; a 3D parametric model configured to receive the predicted body model parameters for each of N detected humans and generate N 3D meshes; and a mesh positioning module configured to place each of the generated N 3D meshes at a respective 3D spatial location in the 3D scene based on the predicted depth parameters and the 2D locations. In addition to any of the above features in this paragraph, N may be greater than one, the body model parameters may comprise pose and shape parameters, and the 3D mesh may be a whole-body mesh. In addition to any of the above features in this paragraph, the decoder may be configured to generate a query from the embedded features for each of the N respective regions to provide N generated cross-attention queries and input the N generated cross-attention queries and the embedded features for each of the plurality of regions into the cross-attention module, wherein the embedded features for each of the plurality of regions provide cross-attention keys and values for the cross-attention module. In addition to any of the above features in this paragraph, the cross-attention module may generate updated queries. In addition to any of the above features in this paragraph, the decoder may further comprise a self-attention module for further updating the queries. In addition to any of the above features in this paragraph, the decoder may further comprise a multi-layer perceptron (MLP) configured to regress the body model and depth parameters from the updated queries. In addition to any of the above features in this paragraph, the instructions may further implement: a camera intrinsics encoder configured to embed intrinsic parameters of the image capturing device; wherein the embedded intrinsic parameters are concatenated with the embedded features for each of the plurality of regions upstream of the decoder. In addition to any of the above features in this paragraph, the intrinsic parameters may comprise embedded values of ray directions from a center of each of the plurality of regions. In addition to any of the above features in this paragraph, the camera intrinsics encoder may comprise a Fourier encoder. In addition to any of the above features in this paragraph, each region may comprise a 2D patch, and the plurality of regions may define a grid of patches forming the 2D image. In addition to any of the above features in this paragraph, the detector may be configured to detect a primary keypoint in each of the N respective regions; wherein each generated 3D mesh is centered around the primary keypoint. In addition to any of the above features in this paragraph, each of the primary keypoints may comprise a human head, torso, midsection, spine, or pelvis. In addition to any of the above features in this paragraph, the detector may be configured to generate, for each of the plurality of regions, a probability that the primary keypoint is present within the region; and determine that the primary keypoint is present by comparing the generated probability to a threshold. In addition to any of the above features in this paragraph, the detector may be further configured to determine a location of each of the N primary keypoints within their respective region by regressing an offset from a center of the respective region. In addition to any of the above features in this paragraph, the mesh positioning module may be configured to, for each generated 3D mesh, determine the 3D spatial location based on the determined location of the primary keypoint and the predicted depth; and place the generated 3D mesh at the determined 3D spatial location in the scene. In addition to any of the above features in this paragraph, the 3D spatial location may be in camera space. In addition to any of the above features in this paragraph, the image encoder may be configured to generate a feature tensor comprising a plurality of feature tokens, each feature token respectively corresponding to each of the plurality of regions and having a feature dimension. In addition to any of the above features in this paragraph, the 3D parametric model may comprise a SMPL-X model. In addition to any of the above features in this paragraph, the image encoder may comprise a Vision Transformer. In addition to any of the above features in this paragraph, the generated 3D meshes may comprise human faces, hands, and feet. In addition to any of the above features in this paragraph, the architecture may further comprise a non-transitory memory for storing the generated 3D meshes. In addition to any of the above features in this paragraph, the system may further comprise a controller and memory for performing a downstream task using the generated 3D meshes. In addition to any of the above features in this paragraph, the downstream task may comprise one or more of: generating a virtual 3D avatar; operating a virtual 3D avatar; controlling movement of an autonomous device, or performing an interaction between a human and an autonomous device. In addition to any of the above features in this paragraph, the downstream task may comprise controlling movement of an autonomous device including collision avoidance based on the generated 3D meshes, and the system may further comprise an actuator coupled to the controller for actuating the autonomous device. In addition to any of the above features in this paragraph, the controller may be coupled to a display for displaying a 3D avatar in an executed virtual reality or augmented reality application. In addition to any of the above features in this paragraph, the decoder may comprise a transformer model. In addition to any of the above features in this paragraph, the system may further comprise an image capturing device comprising a camera.

Additional embodiments provide, among other things, a device comprising: a processor and memory including instructions executable by the processor implementing any of the features in the previous paragraph: at least one image capturing device for obtaining the 2D image; and a downstream task control module that controls an operation of the device based on the generated 3D meshes. In addition to any of the above features in this paragraph, the device may further comprise an actuator controlled using the downstream task control module. In addition to any of the above features in this paragraph, the device may further comprise a display controlled using the downstream task control module.

Additional embodiments provide, among other things, a computer-implemented method for recovering a three-dimensional (3D) whole-body mesh of N humans in a 3D scene, where N is at least one, the method comprising: receiving a two-dimensional (2D) image of the scene from an image capturing device, the 2D image including a plurality of regions; by one or more processors, encoding the received image to extract embedded features for each of the plurality of regions; by one or more processors, detecting N humans in N respective regions among the plurality of regions; by one or more processors, processing the embedded features in the N respective regions and the embedded features for each of the plurality of regions to predict body model and depth parameters for each of the N detected humans, wherein the processing uses a decoder comprising a cross-attention module; providing the predicted body model parameters for each of the N detected humans to a 3D parametric model for generating N whole-body 3D meshes; and placing each of the N generated whole-body meshes at a respective 3D spatial location in the 3D scene based on the predicted depth parameters. The computer-implemented methods may further include any of the features from the preceding paragraphs.

### General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. All publications, patents, and patent applications referred to herein are hereby incorporated by reference in their entirety, without an admission that any of such publications, patents, or patent applications necessarily constitute prior art.

It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between features (e.g., between modules, circuit elements, semiconductor layers, etc.) may be described using various terms, such as “connected,” “engaged,” “coupled,” “adjacent,” “next to,” “on top of,” “above,” “below,” “disposed”, and similar terms. Unless explicitly described as being “direct,” when a relationship between first and second features is described in the disclosure herein, the relationship can be a direct relationship where no other intervening features are present between the first and second features, or can be an indirect relationship where one or more intervening features are present, either spatially or functionally, between the first and second features, where practicable. As used herein, the phrase “at least one of” A, B, and C or the phrase “at least one of” A, B, or C, should be construed to mean a logical (A OR B OR C), using a non-exclusive logical OR, and should not be construed to mean “at least one of A, at least one of B, and at least one of C.”

In the figures, the direction of an arrow, as indicated by an arrowhead, generally demonstrates an example flow of information, such as data or instructions, that is of interest to the illustration. A unidirectional arrow between features does not imply that no other information may be transmitted between features in the opposite direction.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method for recovering a three-dimensional (3D) mesh of N humans in a 3D scene, the method comprising:
receiving a two-dimensional (2D) image of the scene from an image capturing device, the 2D image including a plurality of regions;
by one or more processors, encoding the received image to extract embedded features for each of the plurality of regions;
by one or more processors, detecting N humans in N respective regions among the plurality of regions;
by one or more processors, processing the embedded features in the N respective regions and the embedded features for each of the plurality of regions to predict body model and depth parameters for each of the N detected humans, wherein said processing uses a decoder comprising a cross-attention module;
providing the predicted body model parameters for each of the N detected humans to a 3D parametric model for generating N 3D meshes; and
placing each of the N generated meshes at a respective 3D spatial location in the 3D scene based on the predicted depth parameters.

2. The method of claim 1, wherein N is greater than one, the body model parameters comprise pose and shape parameters, and each generated 3D mesh is a whole-body mesh.

3. The method of claim 2, wherein said processing the embedded features for each of the detected N humans comprises:
generating a query from the embedded features for each of the N respective regions to provide N generated cross-attention queries; and
inputting the N generated cross-attention queries and the embedded features for each of the plurality of regions into the cross-attention module, wherein the embedded features for each of the plurality of regions provide cross-attention keys and values for the cross-attention module.

4. The method of claim 3, wherein the decoder comprises a transformer model, and wherein the cross-attention module generates updated queries.

5. The method of claim 4, wherein said processing the embedded features for each of the detected N humans further comprises:
further updating the updated queries using a self-attention module; and
regressing the body model and depth parameters from the updated or further updated queries;
wherein said regressing the body model and depth parameters from the updated queries uses respective multi-layer perceptrons (MLPs).

6. The method of claim 1, wherein said generating a query further comprises one of (i) combining the embedded features for each of the N respective regions with a learned query initialization based on a 2D position, and (ii) combining the embedded features for each of the N respective regions with mean body model parameters.

7. The method of claim 1, wherein said receiving a two-dimensional (2D) image of the scene from the image capturing device further comprises receiving intrinsic parameters of the image capturing device, the 2D image including a plurality of regions; and
wherein said encoding the received image to extract embedded features for each of the plurality of regions further comprises encoding the intrinsic parameters of the image capturing device.

8. The method of claim 7, further comprising:
before said processing the embedded features for each of the detected N humans, concatenating embedded features for each of the plurality of regions with intrinsic parameters of the image capturing device.

9. The method of claim 8, wherein the intrinsic parameters comprises embedded values of ray directions from a center of each of the plurality of regions, wherein the embedded values are generated using Fourier encoding; wherein each region comprises a 2D patch, and wherein the plurality of regions defines a grid of patches forming the 2D image.

10. The method of claim 1, wherein said detecting N humans comprises detecting a primary keypoint in each of the N respective regions;
wherein each generated 3D mesh is centered around the primary keypoint; and
wherein each of the primary keypoints comprises a human head, torso, midsection, spine, or pelvis.

11. The method of claim 10, wherein said detecting a primary keypoint comprises:
generating, for each of the plurality of regions, a probability that the primary keypoint is present within the region; and
determining that the primary keypoint is present by comparing the generated probability to a threshold;
wherein the generated probabilities for each of the plurality of regions defines a 2D heatmap.

12. The method of claim 11, further comprising:
for each of the N primary keypoints, determining a 2D location of the primary keypoint within the respective region.

13. The method of claim 12, wherein, for each of the N primary keypoints, said determining a location of the primary keypoint within the respective region comprises regressing an offset from a center of the respective region.

14. The method of any of claim 13, wherein said generating a 3D mesh at a 3D spatial location for each of the N detected humans in the 3D scene comprises:
for each generated 3D mesh generated by the 3D parametric model, determining the 3D spatial location based on the determined 2D location of the primary keypoint and the predicted depth; and
placing the generated 3D mesh at the determined 3D spatial location in the scene;
wherein the 3D spatial location is in camera space.

15. The method of claim 14, wherein the extracted embedded features comprise a feature tensor comprising a plurality of feature tokens, each feature token respectively corresponding to each of the plurality of regions and having a feature dimension.

16. The method of claim 1, wherein each generated 3D mesh is an expressive human pose, and each generated 3D mesh comprises human faces, hands, and feet.

17. The method of claim 1, wherein the 3D parametric model comprises a SMPL-X model; and
wherein said encoding the received image uses a Vision Transformer.

18. The method of claim 1 wherein the computer-implemented method is implemented by a neural model;
wherein the neural model is trained using a dataset comprising a synthetic dataset;
wherein the synthetic dataset comprises a generated plurality of images, each including a single human having visible hands positioned in a hand pose;
wherein among the generated plurality of images, the hand poses are diverse.

19. The method of claim 18 wherein the synthetic dataset is a supplement to a dataset including ground truths for the 3D parametric model.

20. The method of claim 1 wherein for each generated 3D mesh, the output parameters for generating each 3D mesh have a dimension that is lower than a dimension of each generated 3D mesh.

21. The method of claim 1, further comprising:
storing each generated 3D mesh; and
performing a downstream task using each generated 3D mesh;
wherein the downstream task comprises one or more of:
generating a virtual 3D avatar;
operating a virtual 3D avatar;
controlling movement of an autonomous device;
performing collision avoidance between a human and an autonomous device based on the generated 3D meshes;
performing an interaction between a human and an autonomous device; and
predicting a response to an interaction between a human and an autonomous device based on the generated 3D meshes.

22. The method of claim 1, wherein the computer-implemented method is implemented by a neural model;
wherein the neural model is end-to-end trained using a loss comprising a human detection loss and at least one regression loss;
wherein the detection loss comprises a cross-entropy loss; and
wherein the at least one regression loss comprises one or more of a parameters loss, an image plane reprojection loss, or a loss for human-centered output meshes.

23. A system for recovering a three-dimensional (3D) mesh of N humans in a 3D scene, comprising:
a processor and memory coupled to the processor, the memory including instructions executable by the processor implementing:
an image encoder configured to receive a two-dimensional (2D) image of the scene including a plurality of regions from an image capturing device and encoding the received image to extract embedded features for each of the plurality of regions;
a detector configured to detect N humans at 2D locations in N respective regions among the plurality of regions in the encoded image;
a decoder configured to process the embedded features in the N respective regions and the embedded features for each of the plurality of regions to predict body model and depth parameters for each of the N detected humans, said decoder comprising a cross-attention module;
a 3D parametric model configured to receive the predicted body model parameters for each of N detected humans and generate N 3D meshes; and
a mesh positioning module configured to place each of the generated N 3D meshes at a respective 3D spatial location in the 3D scene based on the predicted depth parameters and the 2D locations.

24. The system of claim 23, wherein N is greater than one, the body model parameters comprise pose and shape parameters, and the 3D mesh is a whole-body mesh;
wherein the decoder is configured to generate a query from the embedded features for each of the N respective regions to provide N generated cross-attention queries and input the N generated cross-attention queries and the embedded features for each of the plurality of regions into the cross-attention module; and
wherein the embedded features for each of the plurality of regions provide cross-attention keys and values for the cross-attention module.

25. The system of claim 23, wherein the cross-attention module generates updated queries;
wherein the decoder comprises a transformer model;
wherein said decoder further comprises a self-attention module for further updating the queries; and
wherein said decoder further comprises a multi-layer perceptron (MLP) configured to regress the body model and depth parameters from the updated queries.

26. The system of claim 23, further comprising:
a camera intrinsics encoder configured to embed intrinsic parameters of the image capturing device;
wherein the embedded intrinsic parameters are concatenated with the embedded features for each of the plurality of regions upstream of said decoder;
wherein the intrinsic parameters comprise embedded values of ray directions from a center of each of the plurality of regions;
wherein said camera intrinsics encoder comprises a Fourier encoder.

27. The system of claim 23, wherein each region comprises a 2D patch, and wherein the plurality of regions defines a grid of patches forming the 2D image;
wherein said detector is configured to detect a primary keypoint in each of the N respective regions;
wherein each generated 3D mesh is centered around the primary keypoint;
wherein each of the primary keypoints comprises a human head, torso, midsection, spine, or pelvis; and
wherein said detector is configured to
generate, for each of the plurality of regions, a probability that the primary keypoint is present within the region; and
determine that the primary keypoint is present by comparing the generated probability to a threshold.

28. The system of claim 23, wherein said detector is further configured to determine a location of each of the N primary keypoints within their respective region by regressing an offset from a center of the respective region;
wherein said mesh positioning module is configured to:
for each generated 3D mesh, determine the 3D spatial location based on the determined location of the primary keypoint and the predicted depth; and
place the generated 3D mesh at the determined 3D spatial location in the scene; and
wherein the 3D spatial location is in camera space.

29. The system of claim 23, wherein the image encoder is configured to generate a feature tensor comprising a plurality of feature tokens, each feature token respectively corresponding to each of the plurality of regions and having a feature dimension.

30. The system of claim 23, wherein the 3D parametric model comprises a SMPL-X model;
wherein said image encoder comprises a Vision Transformer; and
wherein the generated 3D meshes comprise human faces, hands, and feet.

31. The system of claim 23, further comprising:
memory for storing the generated 3D meshes;
wherein the instructions executable by the processor further implement a controller for performing a downstream task using the generated 3D meshes; and
an actuator coupled to said controller for actuating the autonomous device;
wherein the downstream task comprises one or more of:
controlling movement of an autonomous device using the actuator including collision avoidance based on the generated 3D meshes, and
performing an interaction between a human and an autonomous device.

32. The system of claim 23, further comprising:
memory for storing the generated 3D meshes;
wherein the instructions executable by the processor further implement a controller for performing a downstream task using the generated 3D meshes;
an actuator coupled to said controller for actuating the autonomous device;
wherein the downstream task comprises one or more of:
generating a virtual 3D avatar; and
operating a virtual 3D avatar;
wherein said controller is coupled to a display for displaying a 3D avatar in an executed virtual reality or augmented reality application.

33. The system of claim 23, further comprising:
an image capturing device comprising a camera;
at least one image capturing device for obtaining the 2D image;
wherein the instructions executable by the processor further implementing a downstream task control module that controls an operation of the image capturing device based on the generated 3D meshes;
an actuator controlled using said downstream task control module; and
a display controlled using said downstream task control module.

34. A non-transitory computer-readable medium storing a program including instructions that, when executed by a processor, causes an information processing apparatus to recover a three-dimensional (3D) whole-body mesh of N humans in a 3D scene, where N is at least one, by:
receiving a two-dimensional (2D) image of the scene from an image capturing device, the 2D image including a plurality of regions;
by one or more processors, encoding the received image to extract embedded features for each of the plurality of regions;
by one or more processors, detecting N humans in N respective regions among the plurality of regions;
by one or more processors, processing the embedded features in the N respective regions and the embedded features for each of the plurality of regions to predict body model and depth parameters for each of the N detected humans, wherein said processing uses a decoder comprising a cross-attention module;
providing the predicted body model parameters for each of the N detected humans to a 3D parametric model for generating N whole-body 3D meshes; and
placing each of the N generated whole-body meshes at a respective 3D spatial location in the 3D scene based on the predicted depth parameters.
